(19) United States
(12) Patent Application Publication
(10) Pub. No.: US 2011/0137815 A1
(43) Pub. Date: Jun. 9, 2011

(54) AUTOMATED COMMISSION PROGRAM WITH STATIC TITLED ROOM ASSIGNMENT

(75) Inventors: Roger Barnett, San Francisco, CA (US); Edward Cano, San Ramon, CA (US); Cynthia Pappas, Sarasota, FL (US)

(73) Assignee: SHAKLEE CORPORATION, Pleasanton, CA (US)

(21) Appl. No.: 13/057,145

(22) PCT Filed: Jul. 31, 2009
(86) PCT No.: PCT/US2009/052480

§ 371 Date: Feb. 1, 2011

Related U.S. Application Data
(60) Provisional application No. 61/085,804, filed on Aug. 1, 2008.

(51) Int. Cl. G06Q 10/00

(52) U.S. Cl. 705/320

(57) ABSTRACT

A commission program can include a static titled room assignment to implement a go-forward bonus that is paid on an ongoing basis, regardless of advancement of distributors. An upline assignment summary can store upline assignment information in a compact footprint to increase performance. A sponsored distributor can be assigned to titled rooms of upline distributors at the time the sponsored distributor is sponsored. Sustainability of the program and ongoing compensation can be balanced to achieve superior motivation and compensation to participating distributors.

### CROSS REFERENCE TO RELATED APPLICATION

This application claims the benefit of and priority to U.S. Provisional Application No. 61/085,804 filed Aug. 1, 2008, which is incorporated herein by reference in its entirety.

### BACKGROUND

Multi-level marketing is recognized as a powerful business tool in today's marketplace. With the advent of widespread electronic communications and the emergence of social networking and other online technologies, new opportunities are presented in the multi-level marketing world.

However, various multi-level marketing compensation systems have been found lacking in various respects.

### SUMMARY

A variety of technologies described herein are useful for implementing a commission program in a multi-level marketing environment.

As described herein, titled distributor associations can be assigned between upline distributors and a sponsored distributor. Associations can be used to implement static titled room assignments. An upline assignment summary can be used to store titled room assignments in a compact manner and increase efficiency. Over time, the titled room assignments can be maintained, even as the distributors advance in title. As a result, compensation to an associated distributor based on the titled room assignments can extend for an indefinite period into the future. The plan can include features that balance sustainability of the program and ongoing compensation to achieve superior motivation and compensation to participating distributors.

The resulting commission program can provide an opportunity for an advancing distributor to significantly increase compensation while continuing to do a same amount of work.

As described herein, a variety of other features and advantages can be incorporated into the technologies as desired. The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of a sales organization comprising a distributor with upline distributors and downline distributors.

FIG. 2 is a flowchart of an exemplary method of implementing a compensation plan for distributors via static distributor association assignment.

FIG. 3 is a block diagram showing exemplary systems for representing titled distributor associations.

FIG. 4 is a block diagram of an exemplary representation of an organization and an upline assignment summary.

FIG. 5 is a flowchart of an exemplary method of assigning a sponsored distributor to titled rooms.

FIG. 6 is a flowchart of an exemplary method of assigning upline distributors to an upline assignment summary.

FIG. 7 is a flowchart of an exemplary method of calculating compensation from a compensated distributor perspective.

FIG. 8 is a flowchart of an exemplary method of calculating compensation from a selling distributor perspective.

FIG. 9 is a flowchart of an exemplary method of calculating compensation via static titled room assignment.

FIG. 10 is a flowchart of an exemplary method of assigning distributors to rooms over time as distributors advance in title.

FIG. 11 is a block diagram of an exemplary system for determining an upline assignment summary for a distributor.

FIG. 12 is a flowchart of an exemplary method for determining static titled room assignment for a distributor.

FIG. 13 is a block diagram of an exemplary data structure for storing static titled room assignment for a distributor.

FIG. 14 is a block diagram of a group arrangement for distributors.

FIG. 15 is a flowchart of an exemplary method of calculating compensation based on groups of distributors in a distributor's downline.

FIG. 16 is a block diagram showing personal groups.

FIG. 17 is a block diagram showing personal group volume.

FIG. 18 is a block diagram illustrating differential bonus.

FIG. 19 is a block diagram illustrating break out.

FIG. 20 is an illustration of an exemplary networking scenario.

FIG. 21 is an illustration of administered devices.

FIG. 22 is a block diagram showing genealogies.

FIG. 23 is a block diagram of an exemplary suitable computing environment for implementing any of the technologies described herein.

### DETAILED DESCRIPTION

### Example 1

### Exemplary Overview of Technologies

As described herein, various technologies related to a commission program can be incorporated into a multi-level marketing arrangement to provide superior motivation and compensation for participating distributors.

### Example 2

### Exemplary Compensation

In any of the examples herein, compensation under the program can be paid in the form of a bonus. The bonus can take the form of credit, payment, product, or the like.

### Example 3

### Exemplary Upline

In any of the examples herein, the upline of a subject distributor can include the distributor who sponsored the subject distributor and the upline of the distributor who sponsored the subject distributor (e.g., those who sponsored the sponsoring distributor).

The upline can be determined based on stored relationships between distributors in one or more computer-readable media (e.g., by a computer-implemented method).

### Example 4

### Exemplary Downline

In any of the examples herein, the downline of a subject distributor can include those distributors directly sponsored by the subject distributor and the distributors in turn sponsored by those distributors directly sponsored by the subject distributor, and so forth.

The downline can be determined based on stored relationships between distributors in one or more computer-readable media (e.g., by a computer-implemented method).

In some cases, distributors technically downstream from a subject distributor may not be in the subject distributor's downline because they have broken away. However, breaking away can be inhibited by use of titled rooms as described herein.

A downline can be calculated differently for different aspects of an overall compensation program. So, for example, one program may consider the downline to be one set of distributors, and another program may consider the downline to be another set of distributors. Compensation from both programs can be combined even if they have different definitions of downline.

### Example 5

### Exemplary Combination with Other Commission Programs

The static room assignment technologies described herein can be combined with any number of other commission programs to form an overall commission program. For example, any of the commission programs described herein can be combined with the static upline title assignment technologies. Different genealogies can be used for the other commission programs.

### Example 6

### Exemplary Sales Organization

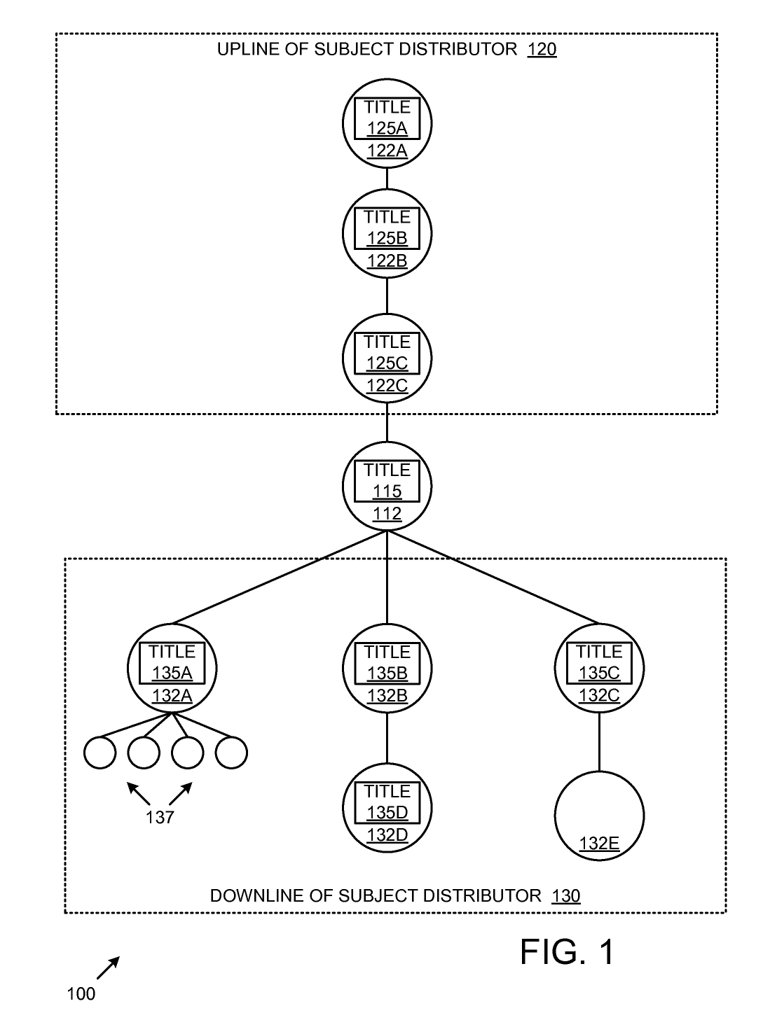

FIG. 1 is a block diagram of a sales organization 100 comprising a distributor 112 with upline distributors and downline distributors. In the example, the subject distributor 112 has an upline 120 and a downline 130. The organization 100 can be represented in a computing device by storing data structures representing the various items and relationships therebetween (e.g., in one or more computer-readable storage media).

The upline 120 of the subject distributor comprises three distributors 122A-C with respective titles 125A-C. In practice, the upline 120 can have more levels (e.g., distributors above distributor 122A).

The downline 130 of the subject distributor comprises distributors 132A-D and, for purposes of illustration, a customer 132E. In practice, the downline 130 can have more distributors, more levels, and more customers. For example, additional distributors 137 may be under a downline distributor 132A. The downline distributors are also shown as having titles 135A-D.

In the example, the customer 132E is shown without a title. Such an arrangement can be used to distinguish between titled and untitled persons in the organization. Alternatively, the customer 132E can be assigned a title of “customer.” The customer 132E is ordinarily considered as outside of the sales organization, but may be part of another sales organization not participating in the compensation plan.

### Example 7

### Exemplary Method of Implementing Commission Program

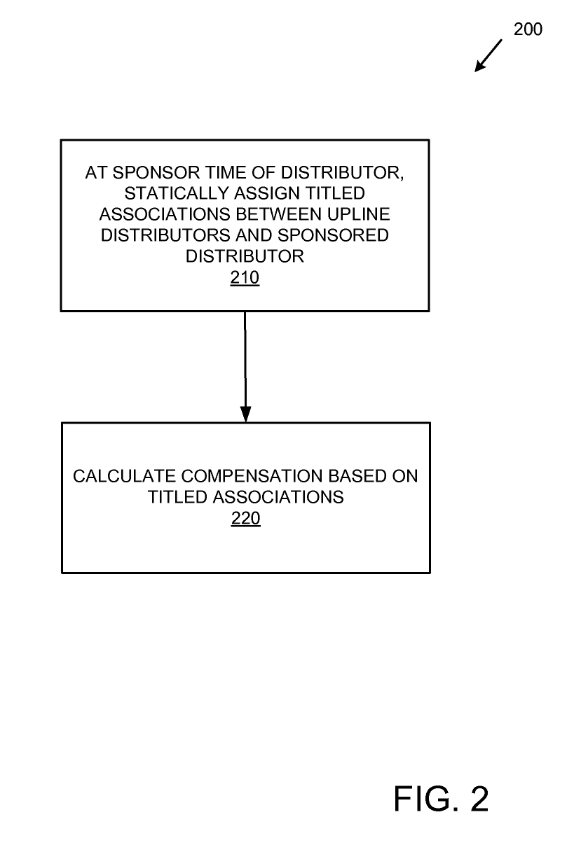

FIG. 2 is a flowchart of an exemplary method 200 of implementing a compensation program for distributors via static distributor association assignment and can be used for a sales organization such as that shown in FIG. 1. The method 200 and any of the other methods herein can be performed by computer-executable instructions stored in one or more computer-readable media (e.g., storage or other tangible media) or stored on a computer program product.

At 210, at sponsor time of a subject distributor in the sales organization (e.g., when the distributor is sponsored, based on when the distributor is sponsored, or the like), titled distributor associations are statically assigned between upline distributors and the subject distributor.

At 220, a compensation amount is calculated based on the titled distributor associations. Compensation can then be awarded based on sales according to the associations.

The method 200 can be reiterated and applied to new distributors when the sponsored distributor sponsors new distributors. The titles may have changed (e.g., one or more distributors have advanced in title), so the new titles in place at the time of sponsorship of the new distributors can affect how the method 200 is applied to new distributors.

Although now explicitly shown, in practice, the compensation amount can be stored (e.g., in one or more computer-readable media). The amount can then be awarded to appropriate distributors.

### Example 8

### Exemplary Compensation Award

In any of the examples herein, awarding compensation can comprise calculating a currency (e.g., dollar) amount and transferring the currency amount to a distributor. Transfer can be accomplished via mailing a check, electronic funds transfer, or the like.

### Example 9

### Exemplary Titled Distributor Associations

In any of the examples herein, a titled distributor association can represent a directed relationship between two distributors in terms of a title. So, for example, a first distributor can be designated as holding an association with a second distributor for a particular title. In practice, such an association can implement the titled rooms as described herein. For example, distributor A can be said to be appearing in distributor B's Title₂ room.

The titled distributor associations can be used when determining compensation.

### Example 10

### Exemplary Titled Rooms

In any of the examples herein, a room can have a distributor assigned to it (e.g., by storing a distributor identifier of the distributor as associated with the room). The rooms for a subject distributor can be associated with respective title names. The number of titles can vary depending on the program. If desired, multiple titles can be assigned to a single room, but the rooms can still be ordered by the title names. For convenience, a title name is sometimes called simply a “title.”

By convention, the titled rooms are shown as being a horizontal set of rooms ordered from left to right, with the leftmost room having the lowest title name, and the rightmost room having the highest title name. However, such depiction is by convention only, and different arrangements can be used with the technologies described herein.

### Example 11

### Exemplary Static Assignment

In any of the examples herein, assignment of titled distributor associations and assignment of distributors to titled rooms can be done statically. Static assignment can be implemented by maintaining assignment of the distributors (e.g., in a titled room or upline assignment summary), regardless of whether distributors assigned to the titled rooms advance in title or the distributor to which the distributors are assigned advances in title.

Thus, if bonuses are paid based on static assignment, the result is that bonuses based on the assignment can be paid to a distributor indefinitely into the future.

Bonuses based on such static assignment can be called “go-forward” bonuses because they can continue into the future indefinitely.

To achieve such static assignment in an efficient manner, various techniques described herein can be applied.

### Example 12

### Exemplary Upline Assignment Summaries

In any of the examples herein, an upline assignment summary can be stored for a distributor (e.g., in one or more computer-readable media). The upline assignment summary can be defined recursively in that the summary of a sponsored distributor can be based on the upline assignment summary of the immediately upline distributor (e.g., sponsoring distributor) at the time the sponsored distributor was sponsored. As described herein, the sponsoring distributor can occupy the first n entries in the summary if the sponsoring distributor has a title of level n at the time the sponsored distributor is sponsored.

In practice, the upline assignment summary can indicate to which titled rooms a subject distributor is assigned. The assignment summary can help reduce the amount of computation needed to determine room assignments because it effectively keeps a running history in a compact footprint. Upline assignment summaries can thus be useful to implement static assignment.

### Example 13

### Exemplary Titled Distributor Associations

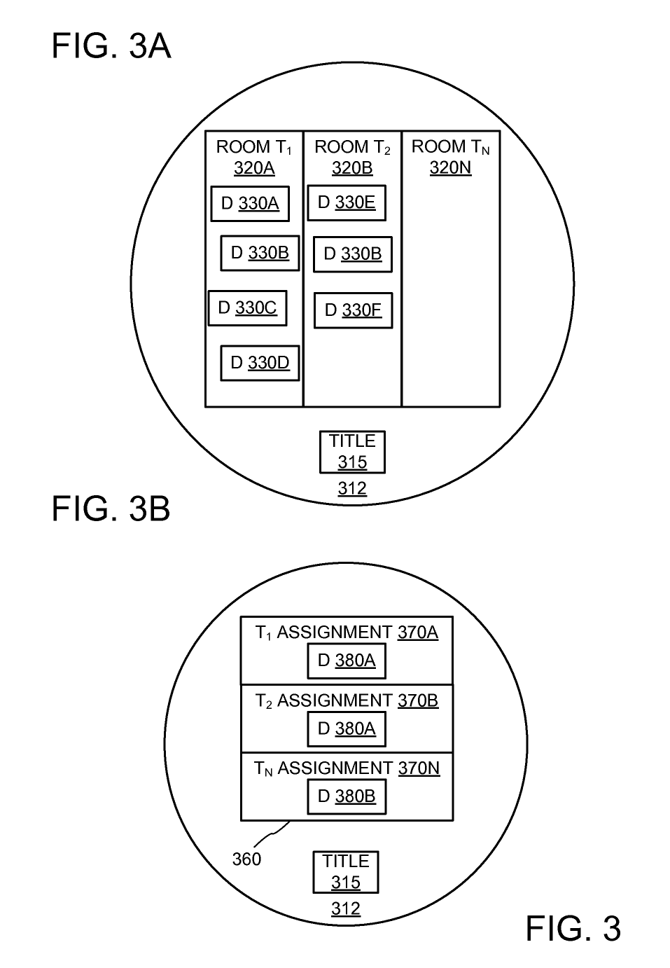

FIG. 3 is a block diagram showing exemplary systems 312 for representing titled distributor associations. FIG. 3A shows titled rooms 320A-N, and FIG. 3B shows an upline assignment summary 360. In practice, both arrangements can be implemented in a single representation 312 of a distributor.

In the example, a representation 312 of a distributor includes a title name 315 for the distributor. For purposes of convenience herein, a representation 312 is sometimes simply called a “distributor.”

FIG. 3A shows that a distributor 312 can have a plurality of titled rooms 320A-N. In the example, the titled room 320A has the title T₁. In practice, an actual title name can be used (e.g., “coordinator”). Downline distributors 330A-F can appear in respective of the distributor rooms. As shown, a distributor 330B can appear in more than one titled room. And, a titled room 320N can be empty (e.g., if the distributor has not yet reached the title or has not yet sponsored anyone after having reached the title).

FIG. 3B shows that a subject distributor 312 can have a plurality of titled entries 370A-N in an upline assignment summary 360. For each titled entry, there is an assigned upline distributor 380A-B. As shown, a single upline distributor 380A can appear in more than one entry of the summary 360 (e.g., if the distributor directly sponsored the subject distributor). The summary 360 can be consulted when the subject distributor 312 sponsors new distributors.

### Example 14

### Exemplary Upline Assignment Summary Equivalence with Titled Rooms

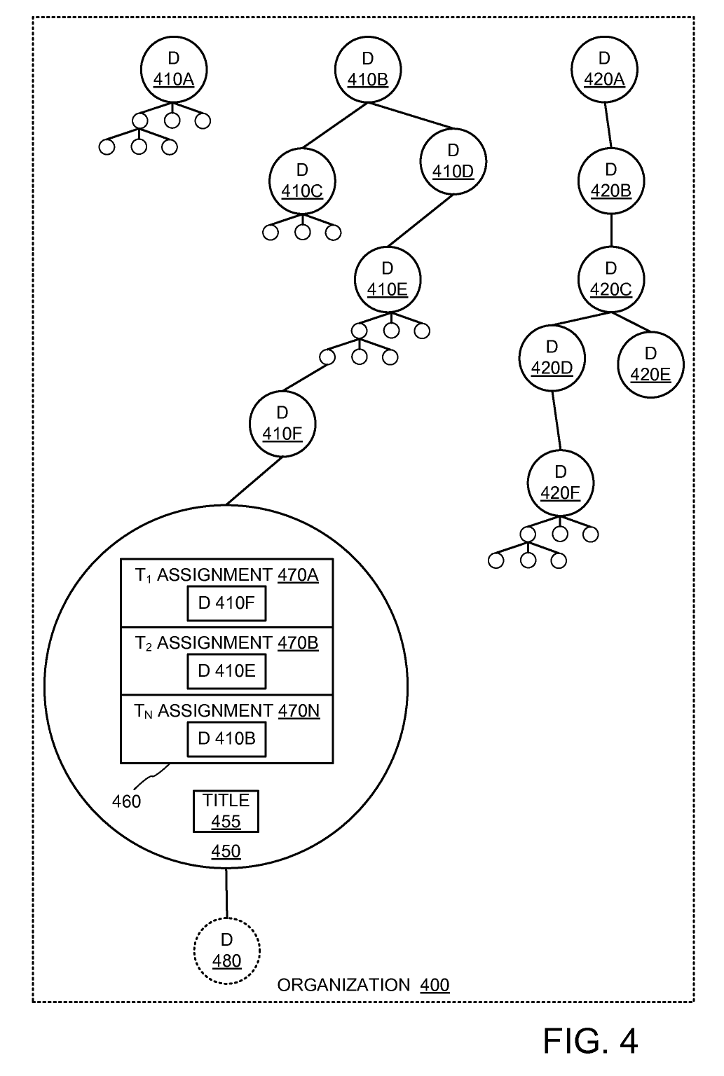

FIG. 4 is a block diagram of an exemplary representation of an organization 400 and an upline assignment summary 460. In practice, a title name 455 is also stored. In any of the examples herein, an upline assignment summary can have an equivalent titled room assignment.

The assignment summary 460 has a plurality of entries 470A-N that indicate titled room assignments for the distributor 450 (e.g., to which rooms the distributor 450 is assigned). In the example, the distributor 450 is assigned to distributor 410F's T₁ room, distributor 410E's T₂ room, and distributor 410B's T_{N} room. Thus, a subject distributor's assignment summary entry for Tₓ indicates that the subject distributor is assigned to the Tₓ room of the distributor listed in the entry.

Storing an assignment entry 460 can improve efficiency when determining compensation amounts. For example, if the assignment entry 460 were not present and instead titled room assignments were stored for each distributor, to determine the compensation for a distributor, the organization would need to be searched to determine in which rooms the distributor appears. Such an approach could require searching many distributor nodes.

Further, if titled room assignments were not stored for each distributor, the problem could become even more complex. A determination of what titles were held by sponsoring upline distributors at the time they sponsored other upline distributors could be performed, but many dates would have to be stored and consulted.

Accordingly, when determining compensation, or when determining room assignments for a sponsored distributor 480, having the upline assignment summary 460 can be more efficient.

### Example 15

### Exemplary Associations: Rooms

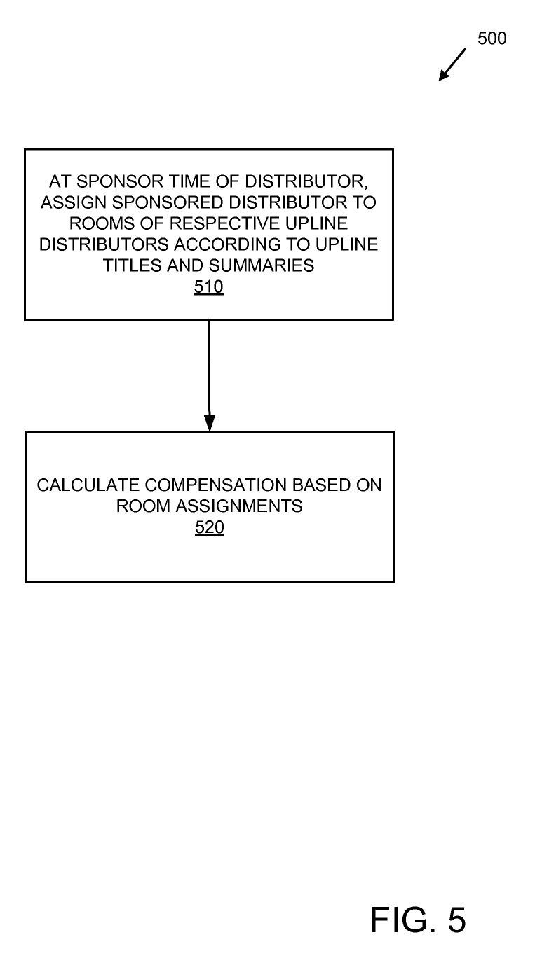

FIG. 5 is a flowchart of an exemplary method 500 of assigning a sponsored distributor to titled rooms. At 510, when a subject distributor is being sponsored, the sponsored distributor is assigned to titled rooms of respective upline distributors according to at least one title of an upline distributor and at least one upline assignment summary.

In practice, the title and summary of the immediately upline (e.g., sponsoring) distributor can be used.

At 520, compensation is calculated based on the titled room assignments. For example, percentages associated with the titles of the titled rooms can be used to determine an appropriate compensation amount.

### Example 16

### Exemplary Associations: Upline Summary

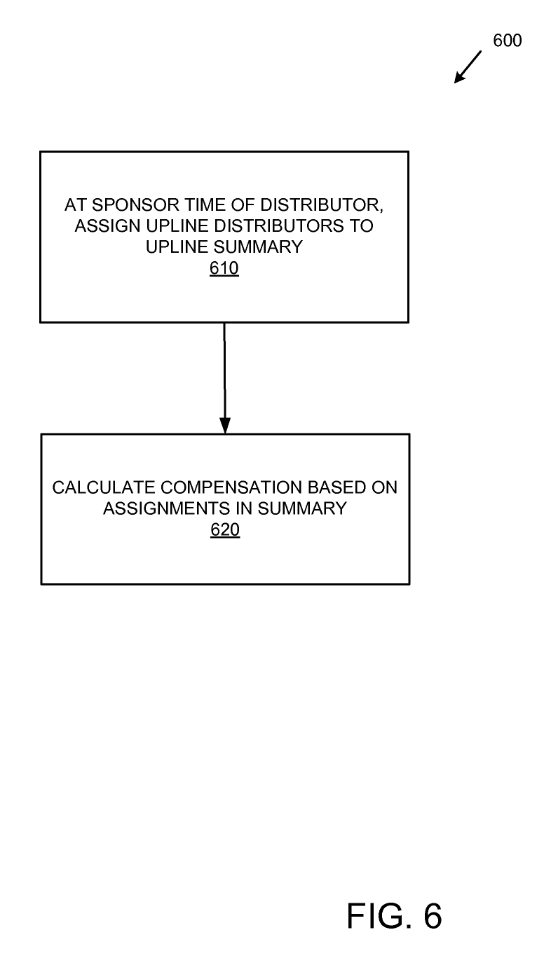

FIG. 6 is a flowchart of an exemplary method 600 of assigning upline distributors to an upline assignment summary.

At 610, when the subject distributor is being sponsored, upline distributors are assigned to the upline assignment summary. For example, if a sponsoring distributor of title n sponsors a subject distributor, the sponsoring distributor can occupy the first n entries of the upline assignment summary. The remaining entries can be taken from (e.g., copied from) the sponsoring distributor's assignment summary. The assignments of the summary can be used to determine to which rooms the subject distributor is assigned. For example, if the summary shows that a first distributor is assigned to the second entry, the subject distributor can be placed in the second room of the first distributor.

At 620, compensation can be based on assignments in the summaries. Because the assignments match the titled room assignments, either technique can be used to calculate compensation. When compensation is based on sales by the sponsored distributor, a sales-based commission can be allocated based on sales by the sponsored distributor among distributors appearing in entries of the assignment summary according to percentages associated with respective entries (e.g., title names) of the assignment summary as described herein.

### Example 17

### Exemplary Compensation Calculation: Compensated Distributor

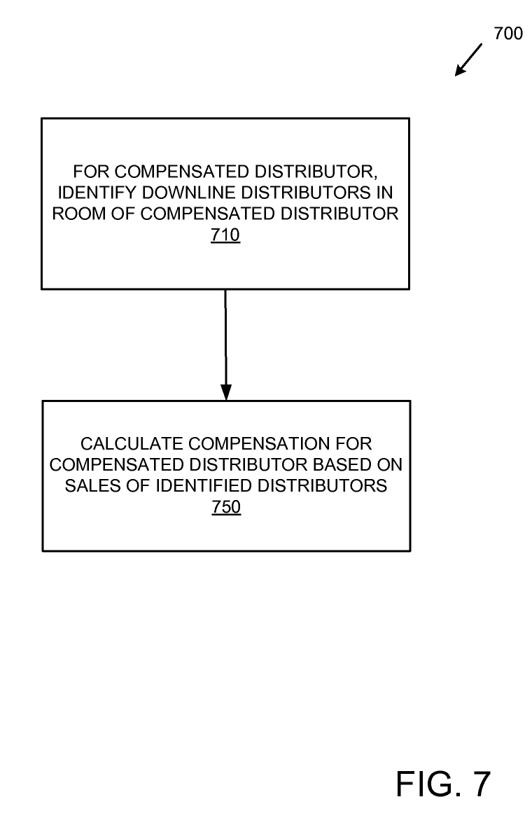

FIG. 7 is a flowchart of an exemplary method 700 of calculating compensation from a compensated distributor perspective and can be used in conjunction with the method of FIG. 2.

At 710, for a compensated distributor, the downline distributors appearing in a titled room of the compensated distributor are identified.

At 750, compensation (e.g., a bonus) is calculated for the compensated distributor based on sales of the identified distributors. Thus, compensation can be based on a plurality of distributors. The compensation can be calculated as the sum of compensations for the respective distributors. Compensation can then be awarded accordingly. The method 700 can be performed for respective titled rooms of the compensated distributor. The technique shown can be performed for each distributor in the organization to determine compensation.

### Example 18

### Exemplary Multi-Tiered Compensation

In any of the examples herein, when calculating a bonus, the room in which the compensated distributor appears can result in different compensation (e.g., different percentages). So, for example, if a compensated distributor appears in a room associated with a first title name, a first percentage can be used (e.g., a percentage associated with the title name). If the compensated distributor appears in a room associated with a second title name, a second percentage different from the first can be used. Some title names may have the same percentages. The percentages can be chosen to balance factors such as the amount of work involved, motivation to the compensated distributor, and sustainability of the plan.

### Example 19

### Exemplary Multiple Rooms

In any of the examples herein, a distributor can appear in multiple entries of an upline assignment summary of another distributor. For example, a high-ranking distributor who directly sponsors a new distributor can be assigned to all entries of the new distributor. When room assignments are based on the summary, the new distributor can thus be assigned to all titled rooms of the high-ranking distributor.

### Example 20

### Exemplary Sales

In any of the examples herein, the sales used to determine compensation for the static titled room assignment compensation plan can be determined in a variety of ways. For example, sales on an ongoing basis can be evaluated on a periodic (e.g., monthly, quarterly, or the like) basis and used to calculate compensation.

Sales can be limited to a particular product, family of products, multiple product lines, or include all sales by the distributor. If desired, sales can include not only sales by the distributor but by those related to (e.g., downline from) the distributor. Or, as described herein, sales by individual distributors can be used in a series of calculations (e.g., for multiple distributors) to achieve a summing effect of sales by different distributors.

### Example 21

### Exemplary Compensation Calculation: Selling Distributor

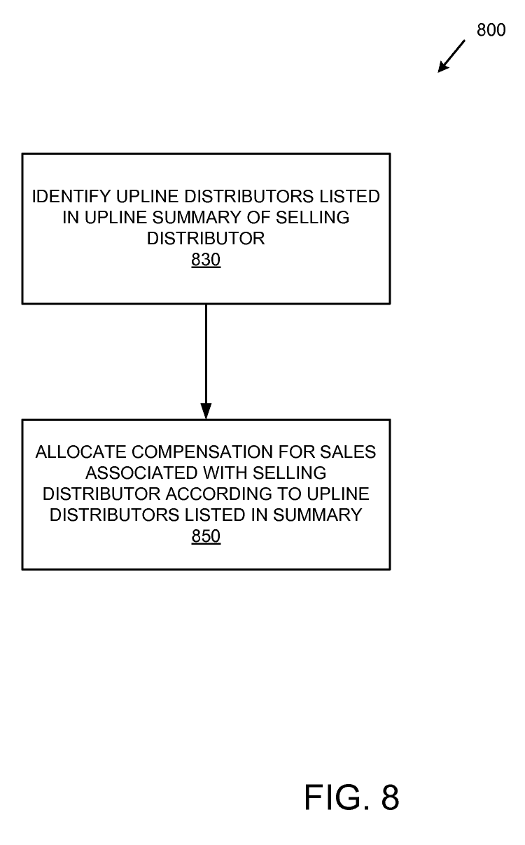

FIG. 8 is a flowchart of an exemplary method 800 of calculating compensation from a selling distributor perspective.

At 830, the upline distributors listed in the upline assignment summary of the selling distributor are identified.

At 840, compensation for sales associated with the selling distributor is allocated to upline distributors listed in the summary of the selling distributor. As described herein, the title names associated with the summary entries can be used to determine how the compensation is allocated (e.g., what percentage is applied to sales). Compensation can then be awarded accordingly.

### Example 22

### Exemplary Compensation Calculation

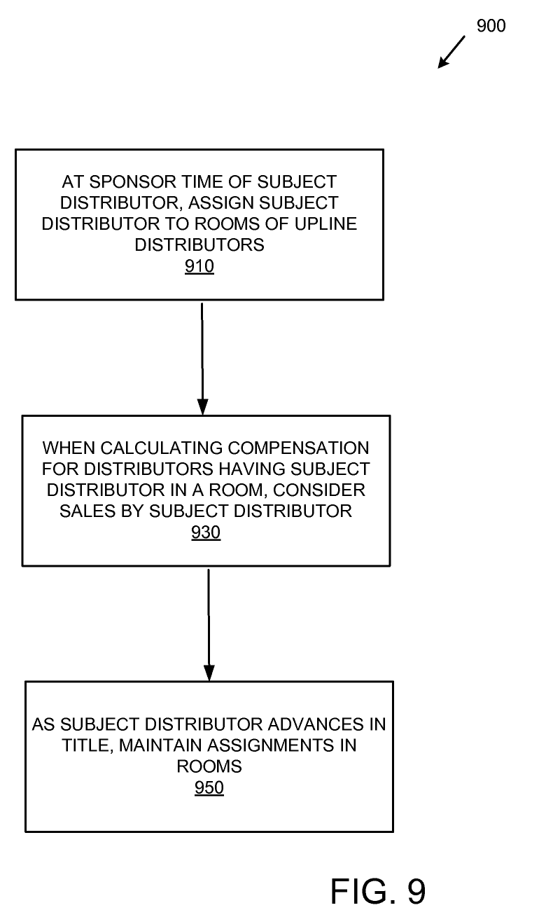

FIG. 9 is a flowchart of an exemplary method 900 of calculating compensation via static titled room assignment.

At 910, at sponsor time of a subject distributor, the subject distributor is assigned to titled rooms of respective upline distributors as described herein.

At 930, when calculating compensation for the distributors having the subject distributor in a room, the sales by the subject distributor are considered. Compensation can be calculated and awarded accordingly over time.

At 950, as the subject distributor advances in title, the titled room assignments for the subject distributor are maintained. Compensation can be calculated repeatedly over time (e.g., as in 930).

### Example 23

### Exemplary Room Assignment over Time

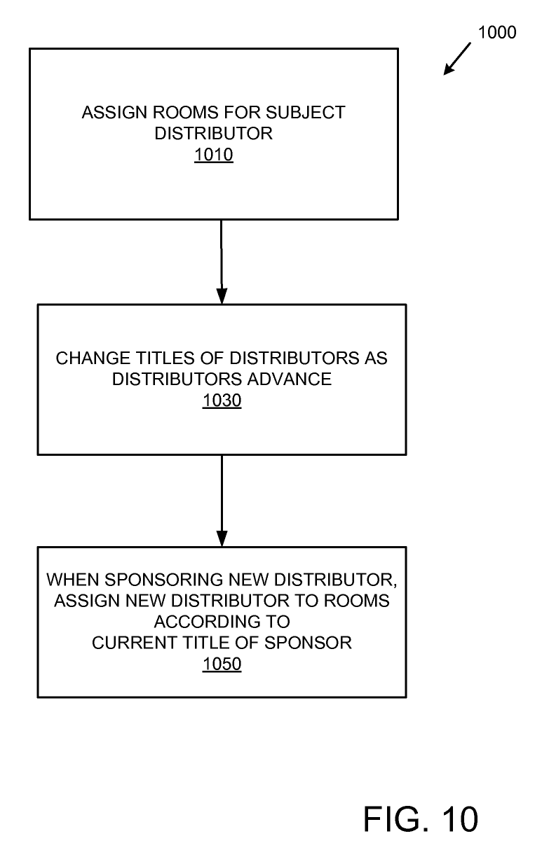

FIG. 10 is a flowchart of an exemplary method 1000 of assigning distributors to rooms over time as distributors advance in title.

At 1010, when a distributor is sponsored, the distributor is assigned to rooms of upline distributors at the time the distributor is sponsored.

At 1030, over time, the titles of distributors are changed as the distributors advance.

For example, the new titles can be stored in one or more computer-readable media.

At 1050, when sponsoring a new distributor, the sponsored distributor is assigned to rooms based at least on the current title of the sponsor.

### Example 24

### Exemplary System for Determining Room Assignment

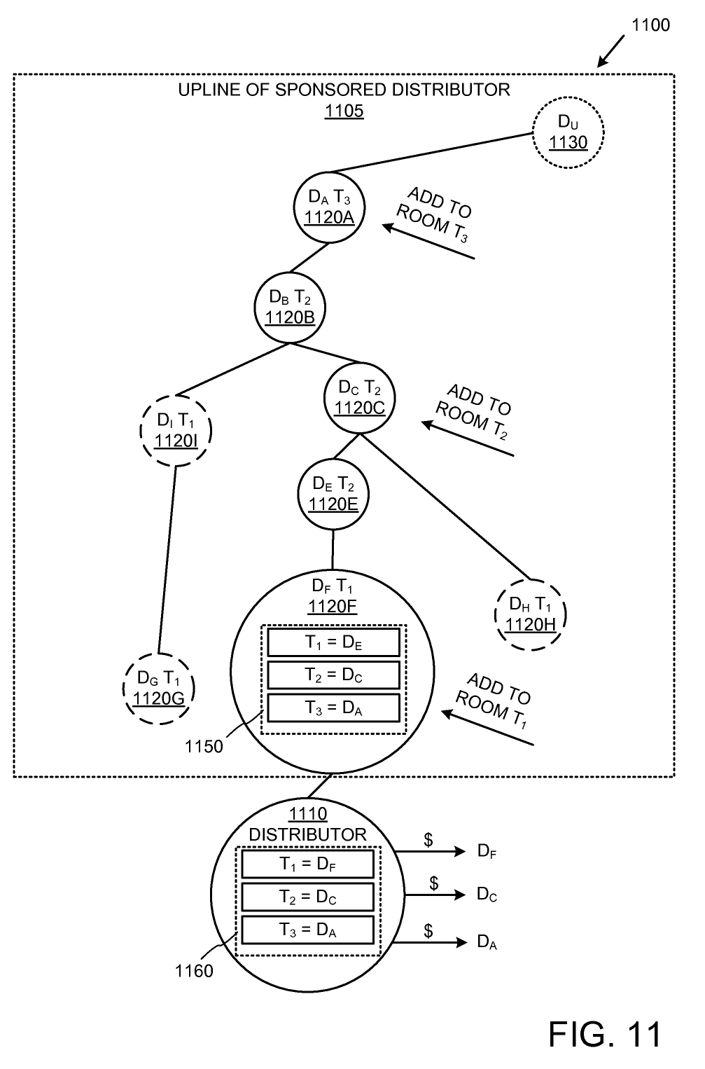

FIG. 11 is a block diagram of an exemplary system 1100 for determining a room assignment for a distributor 1110. The shown items and relationships therebetween can be represented in one or more computer-readable media.

In the example, a subject distributor 1110 at the time of being sponsored has an upline 1105. Distributors in the subject distributor's upline 1105 include distributors 1120A, 1120B, 1120C, 1120E, and 1120F. Distributors 1120G, 1120H, and 11201 need not be counted as part of the upline. The upline may continue to extend beyond 1120A (e.g., to distributor 1130 and beyond).

When determining room assignment, the upline assignment summary 1150 of the sponsoring distributor 1120F can be consulted. As shown in the example, there are three upline assignment summary entries in the summary 1150 of the sponsoring distributor 1120F. Even though distributor 1120E has advanced to a higher title after the sponsoring distributor 1120F was sponsored, static titled room assignment maintains distributor 1120E in the titled room T₁ according to title at the time of sponsorship.

After assignment, there are three upline assignment summary entries in the summary 1160 for the distributor 1110. The distributors are assigned to the entries according to title of the sponsoring distributor 1120F and the upline assignment summary 1150 of the sponsoring distributor 1120F. Accordingly, the distributor 1120E does not appear (and the sponsored distributor is not assigned to any rooms for 1120E) because of an intervening distributor, namely the sponsoring distributor 1120F. Instead, the sponsored distributor is added to rooms for other distributors, who continue to benefit from their own efforts and the efforts of their downline.

As described herein, the subject distributor 1110 is assigned to titled rooms according to the summary.

### Example 25

### Exemplary Top-of-Tree Implementation

Due to the situation arising when starting the commission program, there can be some distributors who are not assigned to certain titled rooms. To represent such a situation, a top-of-tree distributor can be created, and the distributors can be assigned titled rooms of the top-of-tree distributor. The upline assignment summary for a distributor can thus also reflect the top-of-tree distributor.

### Example 26

### Exemplary Initial Upline Assignment

When starting the commission program, initial upline assignment can be done by a specialized computer program that assigns uplines to existing distributors at a point in time. For example, criteria can be used relating to the title held at that point and in the past (e.g., past six months, past year, or the like).

### Example 27

### Exemplary Titled Room Assignment Method

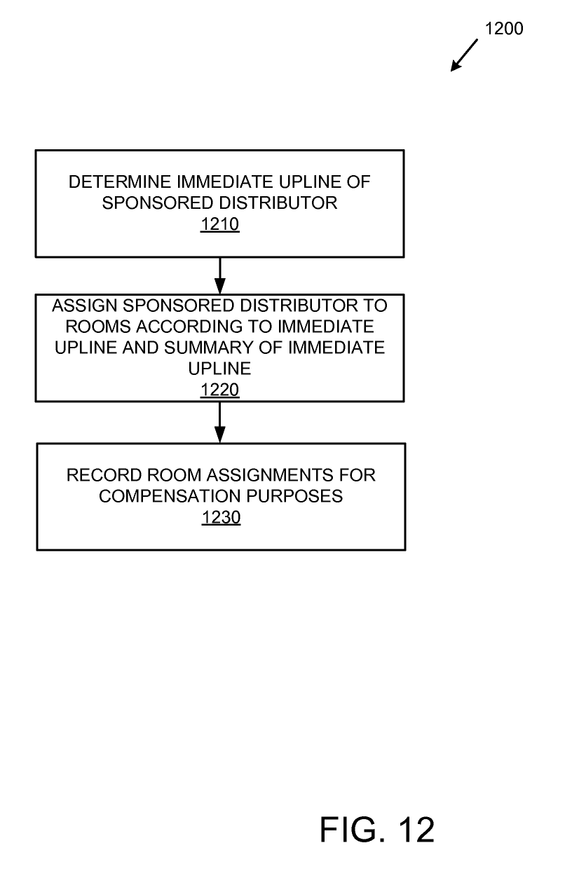

FIG. 12 is a flowchart of an exemplary method 1200 for determining titled room assignment for a distributor and can be used in conjunction with the system 1100 of FIG. 11. As described herein, the method 1200 is typically performed at the time the distributor is sponsored. In any of the examples herein, the assignments determined for an upline assignment summary for a sponsored distributor can be used to assign the sponsored distributor to titled rooms for the upline distributors listed in the summary.

At 1210, the immediate upline (e.g., sponsoring distributor) of the sponsored distributor is determined.

At 1220, the sponsored distributor is assigned to rooms according to the title of the immediate upline and the summary of the immediate upline. Assigning upline distributors to the upline assignment summary of the sponsored distributor can comprise determining a title name of the sponsoring distributor; assigning the sponsoring distributor to entries of the assignment summary having a title name equal to or less than the sponsoring distributor; and for entries having a title name greater than the sponsoring distributor, copying corresponding entries from an assignment summary of the sponsoring distributor.

Thus, if a sponsoring distributor of title Tₙ (at the time of sponsorship) sponsors a sponsored distributor, the sponsoring distributor can occupy the first n entries of the upline assignment summary. The remaining entries can be taken from (e.g., copied from) the sponsoring distributor's assignment summary.

The assignments of the summary can be used to determine to which rooms the sponsored distributor is assigned. For example, if the summary shows that a first distributor is assigned to the second entry, the sponsored distributor can be placed in the second room of the first distributor.

At 1230, the room assignments can be recorded for compensation purposes. In practice, the room assignments can be recorded by storing the assignment summaries, separately storing room assignments, or both. For example, any of the commission programs described herein can be applied to determine compensation based on the room assignments.

Applying the method 1200 to the system 1100 of FIG. 11, distributor 1120F is assigned to the room associated with title name T₁; distributor 1120C is assigned to the room associated with the title name T₂; and distributor 1120A is assigned to the room associated with the title name T₃. As a result of the assignments, there are effectively three go-forward bonuses paid on sales associated with the distributor 1120F. In implementations with r rooms, there are r go-forward bonuses. In some cases (e.g., a distributor is assigned to multiple rooms), more than one of the bonuses can be paid to the same distributor.

### Example 28

### Exemplary Data Structure

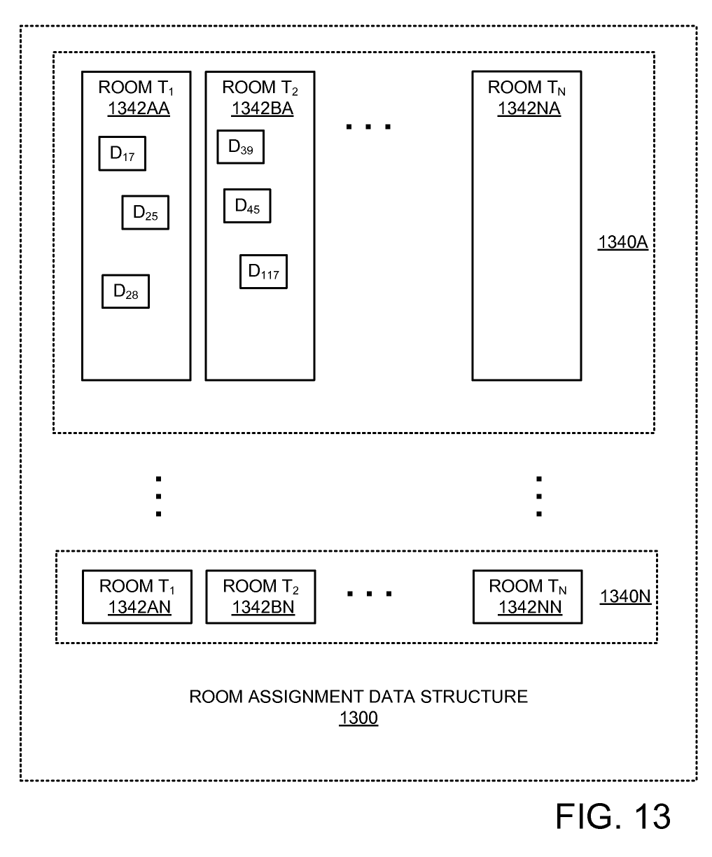

FIG. 13 is a block diagram of an exemplary data structure 1300 for storing static room assignments for a distributor. In the example, the records 1340A-N store respective room assignments 1342AA-NN.

If desired, a distributor identifier uniquely identifying the distributor for whom the rooms are assigned can also be included in the records.

So, for example, the first record 1340A indicates that the distributors having identifiers stored in room 1342AA are the distributors assigned to the subject distributor's first room (e.g., having the first title name, T₁), a distributor identifier stored in room 1342BA is the distributor assigned to the subject distributor's second room, and so forth.

### Example 29

### Exemplary Group Membership

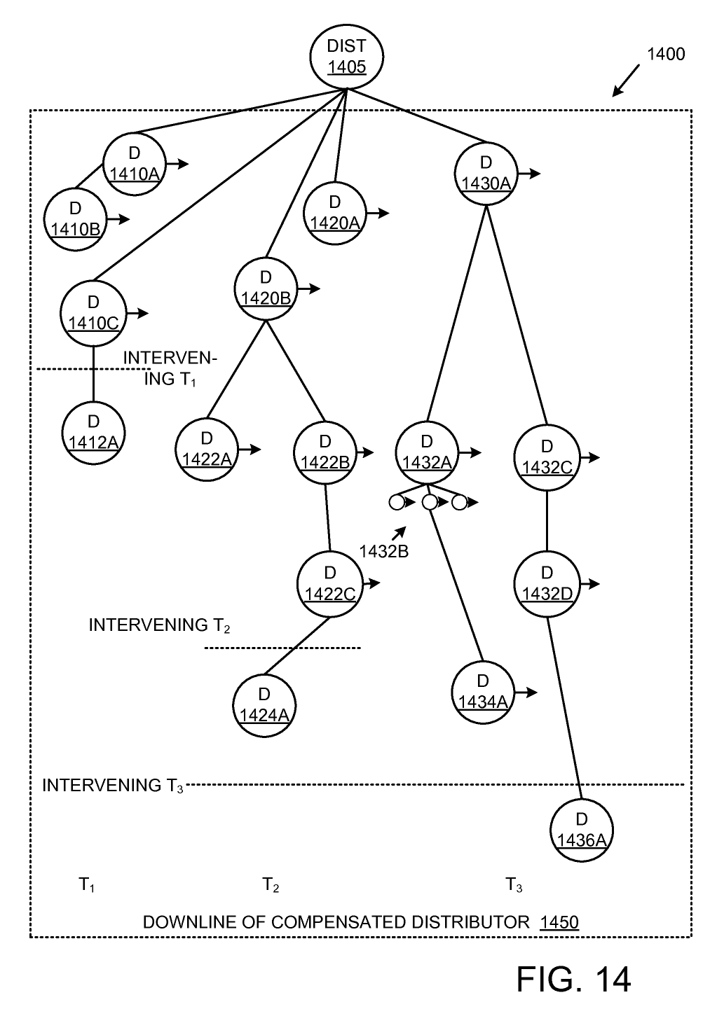

FIG. 14 is a block diagram of an exemplary group arrangement 1400 for distributors. In the example, a distributor 1405 has a downline 1450 with many distributors.

In the example, some distributors 1410A-C and 1412A are considered to be in the subject distributor's T₁ group (e.g., they appear in the subject distributor's T₁ room). These are the distributors that the subject distributor sponsored when the subject distributor had the title T₁ and those sponsored by distributors in the group after the subject distributor advanced from the title T₁, unless there is an intervening distributor of title T₁.

Other distributors 1420A-B, 1422A-C, and 1424A are considered to be in the subject distributor's T₂ group, which is defined similarly to that for the T₁ group.

Still other distributors 1430A, 1432A-D, 1434A, and 1436A are considered to be in the subject distributor's T₃ group, which is defined similarly to that for the T₁ group.

In the example, go forward bonuses payable to the subject distributor 1405 are indicated by the arrows on the distributors.

If, after the subject distributor 1405 advances to title T₂, distributor 1410A sponsors distributor 1410B, 1410B will be added to the subject distributor's T₁ group as long as 1410A has not yet achieved title T₁. If 1410C achieves title T₁ after being sponsored and then sponsors 1412A, no go-forward bonus is paid to the subject distributor 1405 for sales associated with 1412A (e.g., 1412A does not appear in any of 1405's titled rooms) because there is an intervening T₁ distributor. Other compensation may be paid (e.g., generational, leadership, and the like). Even after the subject distributor 1405 achieves title T₂ or T₃, distributors sponsored by distributor 1412A will not be assigned to 1405 rooms because they are part of 1405's T₁ group.

The arrangement can work similarly for other titles as shown.

It is possible to have a partially intervening distributor. So, if a subject distributor appears in multiple rooms of an upline distributor, a partially intervening distributor can cause a situation where distributors downline from the subject distributor are no longer placed in multiple rooms of the upline distributor.

### Example 30

### Exemplary Group Building

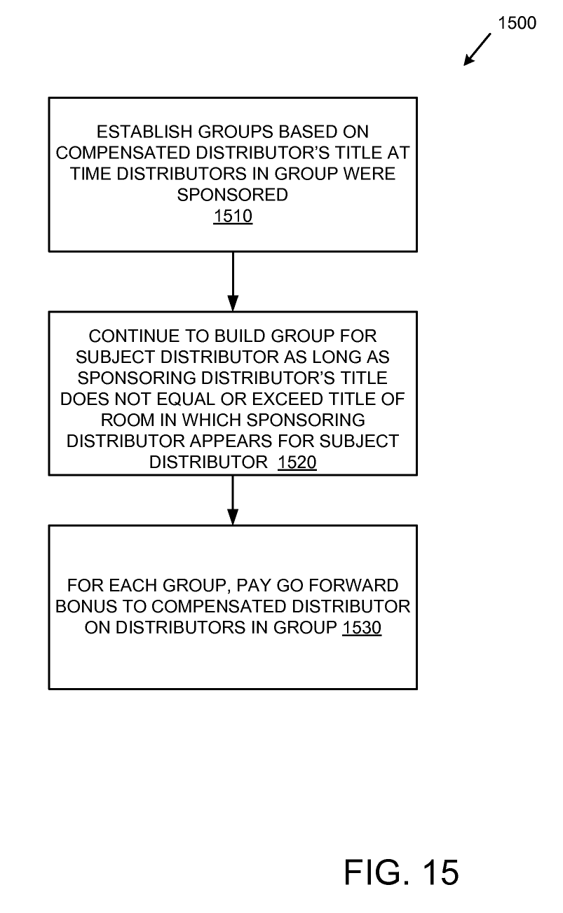

FIG. 15 is a flowchart of an exemplary method 1500 of calculating compensation based on groups of distributors in a distributor's downline.

At 1510, different titled groups for the compensated distributor are established based on the compensated distributor's title at the time distributors in the group were sponsored.

At 1520, additional distributors can be included in the group after the compensated distributor advances to a higher title, as long as the sponsoring distributor's title does not equal or exceed the title of the room in which the sponsoring distributor appears for the subject distributor. In some cases, an intervening distributor's title can also prevent additional distributors from being included in the group.

At 1530, for each group, a go-forward bonus is paid to the compensated distributor for sales of distributors in the group.

### Example 31

### Exemplary Nodes

In any of the examples herein, distributors can be represented as nodes in one or more computer-readable media. For example, as shown herein, the nodes can be associated with respective title names. The node can include a unique identifier identifying the represented distributor. In practice, the nodes can be implemented as database records, linked lists, or the like.

### Example 32

### Exemplary Compensation Engine

In any of the examples herein, a compensation engine can apply the methods described to calculate compensation. For example, a compensation engine can be configured to calculate a go-forward bonus for a subject distributor represented by a node and assigned a plurality of distributors in respective titled rooms according to titled room assignments.

### Example 33

### Exemplary Implementation of Titles

Although any other implementations are possible, an exemplary implementation uses the following ranked titles, ranked from highest to lowest.

| | |
|---|---|
| #6 | Presidential Master |
| #5 | Master Coordinator |
| #4 | Senior Key Coordinator/Key Coordinator |
| #3 | Senior Executive Coordinator/Executive Coordinator |
| #2 | Senior Coordinator/Coordinator |
| #1 | Senior Director/Director |
| #0 | Distributor |

As described herein, a distributor who has not advanced beyond Distributor can be treated as a zero level distributor and not considered for purposes of titled room assignment.

### Example 34

### Exemplary Implementation of Rooms

Although any other implementations are possible, an exemplary implementation uses six rooms for distributors, one for each of the titles 1-6 listed above. Note that multiple business leader titles can be associated with the same room.

### Example 35

### Exemplary Implementation of Percentages

Although any other implementations are possible, an exemplary implementation uses the following percentages when determining compensation (e.g., go forward bonuses) for static room assignment:

| | |
|---|---|
| 11% | Presidential Master |
| 10% | Master Coordinator |
| 9% | Senior Key Coordinator/Key Coordinator |
| 8% | Senior Executive Coordinator/Executive Coordinator |
| 6% | Senior Coordinator/Coordinator |
| 4% | Senior Director/Director |

In practice, the percentages can be applied as follows:

If the selling distributor appears in (e.g., is assigned to) a compensated distributor's Presidential Master room, a 1% commission is paid to the compensated distributor on sales of the selling distributor.

If the selling distributor appears in a compensated distributor's Master Coordinator room, a 1% commission is paid to the compensated distributor on sales of the selling distributor.

If the selling distributor appears in a compensated distributor's Senior Key Coordinator/Key Coordinator room, a 1% commission is paid to the compensated distributor on sales of the selling distributor.

If the selling distributor appears in a compensated distributor's Senior Key Coordinator/Key Coordinator room, a 1% commission is paid to the compensated distributor on sales of the selling distributor.

If the selling distributor appears in a compensated distributor's Senior Executive Coordinator/Executive Coordinator room, a 2% commission is paid to the compensated distributor on sales of the selling distributor.

If the selling distributor appears in a compensated distributor's Senior Coordinator/Coordinator room, a 2% commission is paid to the compensated distributor on sales of the selling distributor.

If the selling distributor appears in a compensated distributor's Senior Director/Director room, a 4% commission is paid to the compensated distributor on sales of the selling distributor.

A selling distributor can appear in multiple rooms, and the commissions can be combined. For example, if a selling distributor appears in all rooms, an 11% commission is paid.

As shown, an escalating percentage can be used wherein lower titled rooms result in a higher percentage.

When allocating a commission based on an upline assignment summary, the percentage associated with the title of an entry in the summary can be applied (e.g., to sales of the distributor having the upline assignment summary) for respective distributors appearing in summary entries (e.g., to whom the commission is allocated).

### Example 36

### Exemplary Alternate Overview

Disclosed herein is a novel multi-level marketing compensation plan. The plan can be used by a company to increase the company's size and distribution network through incentivizing members of the company to sell the company's product. This in turn can result in increased sales which benefits not only the individual members of the company, but the company as a whole.

### Example 37

### Exemplary StairStep/Breakaway Plan

A Stairstep/Breakaway plan is a compensation plan to pay distributors for the sale of products and to encourage those distributors in building and maintaining a sponsorship line. The Stairstep/Breakaway plan is generally designed to achieve two goals. The first goal is to incentivize distributors to sell company products. The second goal is to incentivize the building of a “genealogy” or sponsorship lines.

In one embodiment of such a plan, a company sells products through distributors. Each distributor is incentivized to sell products as well as to find and sponsor new people to participate in the company. In this compensation plan, every product that is sold has a value associated with it called purchase volume (“PV”). PV may be directly related to cost, for example one dollar equals one point of PV, or PV may be based on some arbitrary number, for example a unit of product X is worth 5 points of PV. Thus, a distributor earns increasing amounts of PV based on an increasing amount of sales.

### Example 38

### Exemplary Personal Groups

In addition to earning PV based upon their own sales, a first distributor may also sponsor other people to sell product to other customers and/or other distributors. These individuals are in the first distributor's “personal group.” The first distributor would in turn earn PV from sales of the product by distributors in their personal group (secondary distributors), distributors that are in turn sponsored by people in the first distributor's personal group (tertiary distributors), or other distributors who are even further removed from the first distributor. The company then pays a bonus to the first distributor for the PV that they earned as well as the PV accumulated from second/tertiary/etc. distributors (along with their respective customers) whom the first distributor sponsored.

As a distributor continues to sponsor new distributors, a sponsorship line or genealogy is created where new customers and distributors then go on to sponsor other customers and distributors and so on. The genealogy is recorded and managed in a computer system and can be depicted as a hierarchical representation of everyone in the sponsorship line originating and emanating from the distributor. This genealogy can extend many levels down from the original distributor.

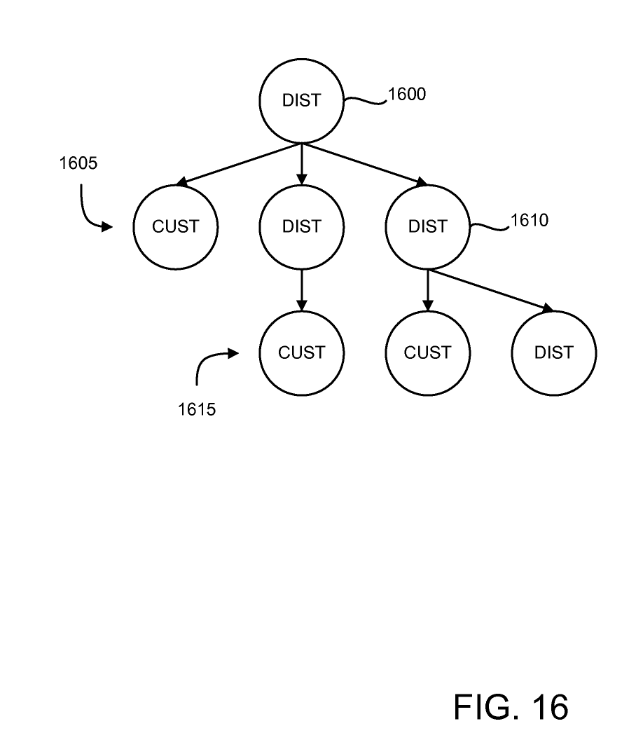

FIG. 16 provides an example of this relationship. A distributor 1600 supplies a customer and additionally sponsors two other distributors at a second level 1605. Each of the distributors at the second level 1605 supplies or sponsors at least one person at a third level 1615. One of the second level distributors 1610 supplies a customer and sponsors a distributor at the third level 1615. In this example, the first distributor 1600 would earn PV off of sales to the customers at the second level 1605 and the third level 1615, as well as PV on sales to or from the distributors at the second or third levels. Generally, the distributor 1600 would be said to be in the “upline” of the second level 1605 or third level 1615 entities. Conversely, the second level distributor 1610 would be said to be in the “downline” of the distributor 1600.

The PV generated in the personal group is referred to as personal group volume (“PGV”). PGV includes all of the PV that the distributor generates through personal purchases and personal product sales. PGV further includes all of the PV generated from sponsored distributors who purchase and/or sell product to their customers, and so on. All of the PV within the distributor's personal group counts towards the distributor's personal group volume.

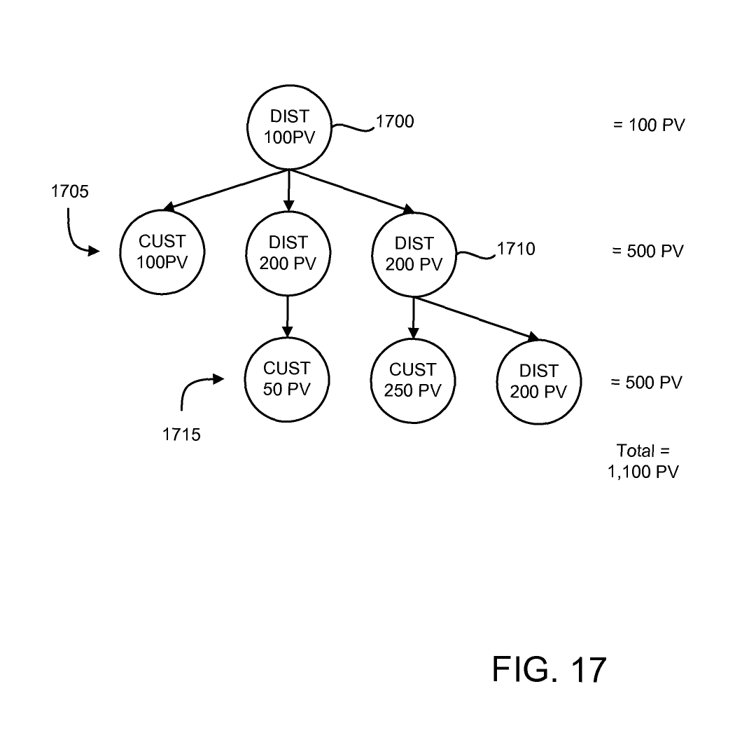

FIG. 17 illustrates an example of PGV. The first distributor 1700 generates 100 PV through personal purchases. The first distributor 1700 sponsors two distributors and sells to a customer at a second level 1705. The two second level distributors each generate 200 PV, and the customer generates 100 PV through purchases. Thus, 500 PV is generated at the second level 1705. The two distributors at the second level together sponsor two customers and a distributor at the third level 1715. One of the customers generates 50 PV, while the other generates 250 PV. The third level distributor generates 200 PV. Thus, there is a total of 500 PV generated at the third level 1715. Because the first distributor 1700 sponsors or sells to, either directly or indirectly, each of the people in the second and third levels 1705, 1715, the PV generated by each of these people is added to the first distributor's PGV. Thus, the first distributor 1700 has 1,100 PGV. Similarly, the distributor 1710 in the second level 1705 has 650 PGV due to their own PV, the PV of the customer in the third level 1715 that they sell to, and the PV of the distributor in the third level.

By meeting specific PGV benchmarks, the distributor may earn a personal group bonus (“PGB”) on the PGV generated in his or her personal group. Generally, the personal group Bonus is a percentage, such as 4%, 8%, etc. on the PGV generated by his or her personal group. As the PGV increases, the PGB percentage that will be paid to the distributor increases as well. Table 1 describes one exemplary PGB schedule, although different PGV benchmarks and PGB rewards may also be used as circumstances dictate.

TABLE 1

| PGV Benchmarks | PGB Percentages |
|---|---|
| 250 PGV | 4% PGB |
| 500 PGV | 8% PGB |
| 1,000 PGV | 12% PGB |
| 2,000 PGV | 16% PGB |

In this example, PGB percentages are paid up to 2,000 PGV. Anything beyond 2,000 PGV is still paid at a 16% PGB rate. Additionally, PGB is a differential bonus. This means that if a given distributor qualifies at the 4% level, then the next distributor upline who qualifies at 8% or higher will receive the difference between the distributor's qualified percentage and the 4% already paid. This process continues until the 16% is fully paid out.

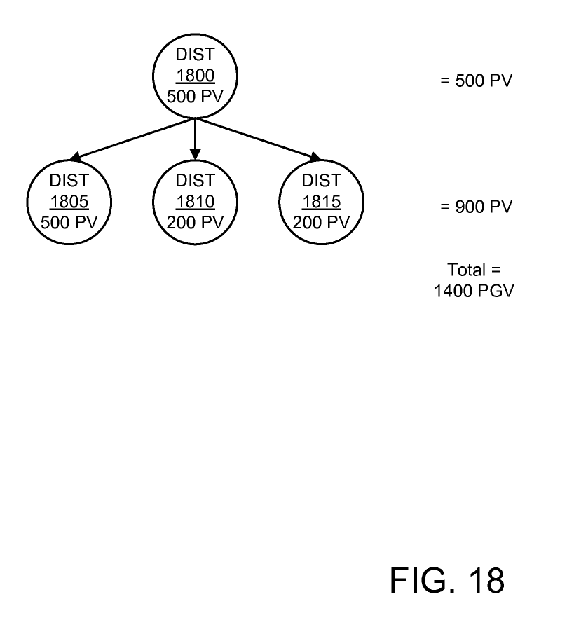

FIG. 18 illustrates the differential bonus concept. Distributor 1800 is eligible, under the plan shown in Table 1, to earn a 12% PGB on his or her own volume and on the volumes of distributors 1810 and 1815 because distributor 1800 has 1,400 PGV. However, distributor 1805 has 500 PV, and so distributor 1805 is eligible to earn a PGB bonus of 8%. Thus, distributor 1800 earns the difference between their own PGB of 12% and the 8% PGB distributor 1805 is eligible to earn, so distributor 1800 only earns a PGB of 4% on the PV of distributor 1805. Note that this reduced PGB ONLY applies to the PV of distributor 1805. In this example, distributor 1800 earns:

| | | |
|---|---|---|
| Own = | 500 PV × 12% = | $60 |
| Dist 1805 = | 500 PV × 4% = | $20 |
| Dist 1810 = | 200 PV × 12% = | $24 |
| Dist 1815 = | 200 PV × 12% = | $24 |

| | |
|---|---|
| Total PGB bonus to Dist 1800 = | $128 |

Note that in this example, distributor 1805 would earn 500 PV×8%=$40 on their own PV. Additionally, in this example the 16% level is reserved for those distributors with a minimum title of “director,” as described in the next section, although this may not be true in other embodiments.

### Example 39

### Exemplary Business Groups

Within one embodiment of the business plan, there are leadership levels that have specific names or titles. These leadership titles make up a career path. A distributor may grow his or her personal group to the point where the distributor is eligible to enter the leadership career path. A distributor who enters the career path is termed a “business leader.” In the examples described below the career path is defined using terms generally reserved for companies such as “director,” coordinator,” etc. In other embodiments military designations such as “captain,” “lieutenant,” etc.; precious metals designations such as “diamond level,” “platinum level,” etc.; or some other designations could be used.

In this example, the first title within the career path is the “director” title. When a distributor becomes a director he or she then “breaks away” or “breaks out” of his or her business leader's personal group. The new director takes his or her own personal group, and the PGV from that personal group, with himself or herself. This PGV no longer counts towards PGB percentages for the upline sponsorship line of the director. Instead, the PGV is added to and included in the business group volume (“BGV”) of the first business leader upline from the new director. The new director and his or her personal group are considered a 1^{st} generation business leader from the first upline business leader found within the sponsorship line. Each successive business leader is then counted as a generation. For example, the second business leader found downline in the sponsorship line is a 2^{nd} generation business leader, and the third business leader is a 3^{rd} generation business leader, and so on.

This generational lineage occurs regardless of how many personal group levels the new director is from his or her first upline business leader. Because each business leader is a next generation, each generation can be many levels in the sponsorship line away from the next business leader.

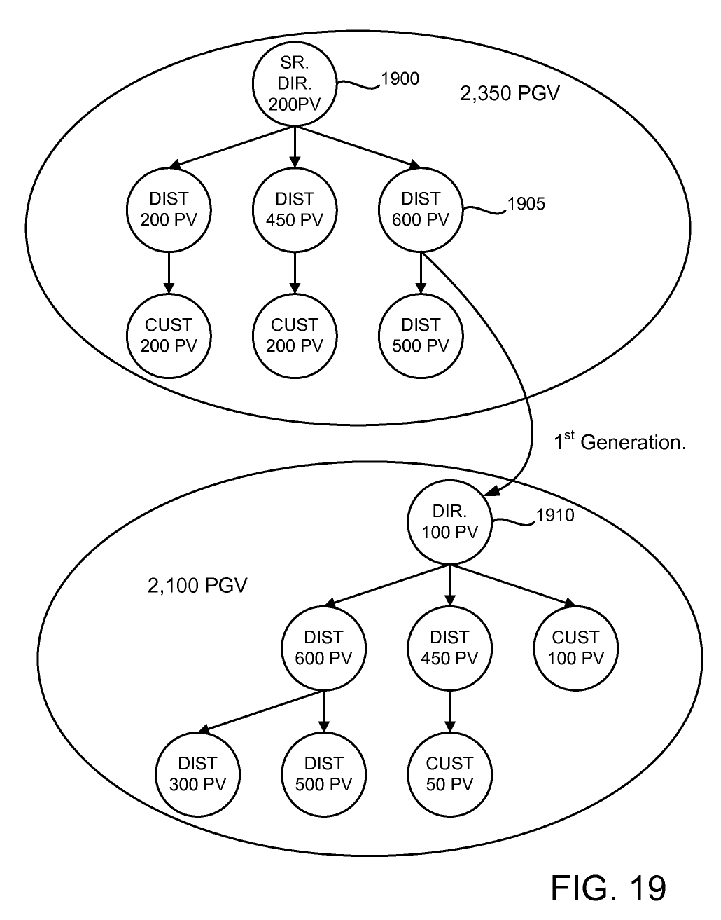

FIG. 19 illustrates a distributor that became a director and broke out of his or her PGV upline. In FIG. 19 a senior director 1900 sponsors a distributor 1905 who, in turn, sponsors a distributor that just promoted to a director 1910. The new director 1910 thus breaks out of the PGV downline of the senior director 1900 and the distributor 1905, and takes their own PGV with him or her. The senior director's 1900 PGV in this case is only 2,350 PGV because now the sales made to or by the new director 1910 are not counted towards the PGV of the senior director. Similarly, the new director 1910 has 2,100 PGV. Note that in this example the director 1910 is two levels away from the senior director 1900 (senior director 1900 distributor 1905→director 1910), however the director is only a single generation away from the senior director 1900, because the senior director is the next business leader upline from the director.

In this embodiment, business leaders are paid a percentage on the PGV generated by each generation of business leaders. This percentage is paid up to a set number of generations within their business group. Table 2 shows business leader names and relative percentages below. In other examples a company may pay more or less generations, and the relative percentages may be different.

TABLE 2

| | | | | | | Sr. | | Sr. | | |
|---|---|---|---|---|---|---|---|---|---|---|
| | | Sr. | | Sr. | Executive | Executive | Key | Key | Master | Pres. |
| | Director | Director | Coordinator | Coor. | Coor. | Coor. | Coor. | Coor. | Coor. | Master |
| 1^{st} | | 7% | 7% | 7% | 7% | 7% | 7% | 7% | 7% | 7% |
| Gen. | | | | | | | | | | |
| 2^{nd} | | | 5% | 6% | 6% | 6% | 6% | 6% | 6% | 6% |
| Gen. | | | | | | | | | | |
| 3^{rd} | | | | | 4% | 4% | 5% | 5% | 5% | 5% |
| Gen. | | | | | | | | | | |
| 4^{th} | | | | | | | 3% | 3% | 4% | 4% |
| Gen. | | | | | | | | | | |

In Table 2, the company pays a generational bonus up to four generations deep, depending on the business leader's title. The volume created by all of the PGV within each business leader's personal group (to four generations) is combined to make up the business leader's business group volume. As a business leader increases in title, he or she is eligible to earn additional generational bonuses (as shown in Table 2.)

### Example 40

### Exemplary Plan Enhancements

Disclosed herein are two enhancements to the Stairstep/Breakaway plan described above, a “starter program” and a “bonus plan.” The purpose of these enhancements is to encourage further participation and sponsorship by distributors and business leaders by adding incentives for further work both in terms of sales and in terms of development of down-line individuals.

The main objectives of the bonus plan and the starter program are to create growth through the following mechanisms:

1. Drive Sponsoring

2. Drive Business Building

3. Drive Title Advancement

Starter program bonuses can be implemented according to Example 49, below. Generally, the bonuses are paid as new individuals are sponsored into the company through a starter pack. The starter pack can include product, product literature, and/or a product coupon on the next purchase of product. The starter pack may also contain other information. In one example, for each starter pack sold, up to a total of $125 can be paid in commissions to the sponsor and the sponsor's upline.

The starter program and the bonus plan establish and use lines of sponsorship that are separate and apart from each other. The lines of sponsorship are also separate and apart from the lines of sponsorship used by the Stairstep/Breakaway plan. One term for describing these separate lines of sponsorship is “assignment.”

In the Stairstep/Breakaway Plan described above, the relationship is always one sponsor to many sponsored customers or distributors. As time progresses, the title of the sponsor in relation to when the person sponsors someone is not important from the standpoint of the overall sponsorship line. In other words, everyone that is sponsored is always sponsored into the sponsor's personal group, regardless of the current title that the sponsor holds.

In the starter program and the bonus plan, by contrast, the title of the sponsor and that of the sponsor's uplines is of importance. In the starter program, a distributor newly sponsored into the company is assigned to up to four uplines, beginning with the distributor's sponsor. The new distributor is separately “assigned” up to six upline business leaders who already hold a title in the company for purposes of the bonus plan. This assignment may be automatic or there may be some degree of chance or decision making involved in it, and it may involve a computer and/or human input. This assignment remains in place regardless of titles subsequently achieved by the new distributor or by any of the assigned upline business leaders. How someone new into the company is assigned depends upon several factors including the status or title of their sponsor, the business rules of the starter program, and the assignment already in place of the sponsor's upline. The assignments determine how much of a starter program bonus and a bonus plan bonus are paid.

A terminology that is helpful to conceptualize the assignments is “rooms.” To depict a distributor's assignment in relation to his or her sponsor and sponsorship line upline, the concept of phases or rooms can be used. Each room is tied to a title, or position, within the business leader career path. As a business leader increases in title and moves up the career path, the business leader progresses from left to right through these rooms and builds genealogies in each room into which newly sponsored distributors are assigned. In some cases, such as Table 3 below, multiple business leader titles may be in the same room. In alternative embodiments, more or less rooms could be used.

TABLE 3

| | Room | | | | | |
|---|---|---|---|---|---|---|
| | #1 | #2 | #3 | #4 | #5 | #6 |
| Room | Director/ | Coordinator/ | Executive Coor./ | Key Coor./ | Master | Presidential |
| Name | Sr. | Sr. Coor. | Sr. Exec. | Sr. Key Coor. | Coordinator | Master |
| | Director | Room | Coor. | Room | Room | Room |
| | Room | | Room | | | |

A new distributor is assigned an upline depending on the title held by the sponsor and the sponsor's already-assigned upline. By way of example using arbitrary names, if Larry is a presidential master, then anyone that Larry sponsors will be placed in his Presidential Master Room (Room #6 in Table 3.) If Larry sponsors a new distributor, Kim, Kim would be assigned to Larry for all 6 rooms in Kim's career path. Kim's upline assignment would look like this:

| | | |
|---|---|---|
| #6 | Presidential Master: | Larry |
| #5 | Master Coordinator: | Larry |
| #4 | Key/Sr. Key Coor.: | Larry |
| #3 | Exec./Sr. Exec. Coor.: | Larry |
| #2 | Coor./Sr. Coor.: | Larry |
| #1 | Dir./Sr. Dir.: | Larry |

| | |
|---|---|
| Distributor: | Kim |

If Kim subsequently achieves the rank of executive coordinator. Kim would thus be in room #3. If Kim sponsored Kathy at that point, then Kathy's upline assignment would look like this:

| | | |
|---|---|---|
| #6 | Presidential Master: | Larry |
| #5 | Master Coordinator: | Larry |
| #4 | Key/Sr. Key Coor.: | Larry |
| #3 | Exec./Sr. Exec. Coor.: | Kim |
| #2 | Coor./Sr. Coor.: | Kim |
| #1 | Dir./Sr. Dir.: | Kim |

| | |
|---|---|
| Distributor: | Kathy |

Now, when Kathy in turn becomes a director and sponsors Jeff, then Jeffs assignment would include Larry, Kim and Kathy. For example:

| | | |
|---|---|---|
| #6 | Presidential Master: | Larry |
| #5 | Master Coordinator: | Larry |
| #4 | Key/Sr. Key Coor.: | Larry |
| #3 | Exec./Sr. Exec. Coor.: | Kim |
| #2 | Coor./Sr. Coor.: | Kim |
| #1 | Dir./Sr. Dir.: | Kathy |

| | |
|---|---|
| Distributor: | Jeff |

Note that these assignments are determined at the time of sponsoring. In other words, once set, the assignments do not change. Even as Kathy moves up in rooms, Jeffs assignments of Larry, Kim, and Kathy will not change. However, if Kathy moved up to an executive coordinator (thus in the same room as Kim was when Kim sponsored Kathy), and sponsored George, then George's upline would look like this:

| | | |
|---|---|---|
| #6 | Presidential Master: | Larry |
| #5 | Master Coordinator: | Larry |
| #4 | Key/Sr. Key Coor.: | Larry |
| #3 | Exec./Sr. Exec. Coor.: | Kathy |
| #2 | Coor./Sr. Coor.: | Kathy |
| #1 | Dir./Sr. Dir.: | Kathy |

| | |
|---|---|
| Distributor: | George |

In this case, Kim is irrelevant to George because Kathy is in the same room as Kim was (room #3) when Kim sponsored Kathy.

### Example 41

### Exemplary Bonus Plan Percentages

As a business leader progresses up the career path, the business leader becomes eligible to earn additional bonus plan percentages. These percentages are added to what has already been earned in previous rooms. For example, as a business leader increases in title from sr. director to coordinator, the new coordinator would earn a higher percentage than the sr. director. Table 4 shows an example of both the bonus increase (labeled Bonus Plan Bonus) as an individual moves from one room to the other, and also the cumulative bonus per room. Other embodiments may have higher or lower percentage differences between rooms.

TABLE 4

| | Room | | | | | |
|---|---|---|---|---|---|---|
| | #1 | #2 | #3 | #4 | #5 | #6 |
| Room | Director/ | Coordinator/ | Executive Coor./ | Key Coor./ | Master | Presidential |
| Name | Sr. | Sr. Coor. | Sr. Exec. | Sr. Key Coor. | Coordinator | Master |
| | Director | Room | Coor. | Room | Room | Room |
| | Room | | Room | | | |
| Bonus Plan Bonus | +4% | +2% | +2% | +1% | +1% | +1% |
| Bonus Plan | 4% | 6% | 8% | 9% | 10% | 11% |
| Cumulative Bonus | | | | | | |

Thus, a sr. director achieving coordinator status would be eligible to achieve a 6% bonus plan bonus. The 4% from being a director/sr. director, and the additional 2% received by becoming a coordinator.

Because bonus plan bonuses are paid as percentages on volume occurring, as opposed to a fixed dollar amount, bonus plan bonuses are reoccurring each month on the volume that is generated. In other words, the bonuses are percentages applied to actual sales, as opposed to a fixed monetary amount (i.e. 3% of $2,000 for one level, 5% of $2,000 for another level, etc.). This serves to help incentivize business leaders to motivate their sales team because as the business leader's sales team sells more, the business leader receives a correspondingly higher bonus. Additionally, this plan is unique in that it pays bonus plan bonuses in every room on all products sold as opposed to bonuses only on starter packs or other products specified by a company.

### Example 42

### Exemplary Additive Bonus Plan Bonuses

In the present embodiment, the bonus plan bonuses described in Table 4 increase both the PGB bonuses shown in Table 1 and the generational bonuses shown in Table 2.

As shown in Table 1, a new director is qualified to earn up to 16% on his or her personal group for those customers and distributors that were sponsored prior to the individual becoming a director. The director will, however, earn 20% on any new people that he or she sponsors into the director room. This is because the 4% bonus plan bonus (shown in Table 4) is added to the personal group bonus of 16% that he or she is qualified to earn as a director as shown in FIG. 1. Table 5 provides an example of the bonuses available to a business leader in each room:

TABLE 5

| | Room | | | | | |
|---|---|---|---|---|---|---|
| | #1 | #2 | #3 | #4 | #5 | #6 |
| Room | Director/ | Coordinator/ | Executive | Key Coor./ | Master | Presidential |
| Name | Sr. | Sr. Coor. | Coor./ | Sr. Key | Coordinator | Master |
| | Director | Room | Sr. Exec. | Coor. | Room | Room |
| | Room | | Coor. | Room | | |
| | | | Room | | | |
| Bonus Plan Bonus | +4% | +2% | +2% | +1% | +1% | +1% |
| Bonus Plan Cumulative | +4% | +6% | +8% | +9% | +10% | +11% |
| Bonus | | | | | | |
| Business Leader | +16% | +16% | +16% | +16% | +16% | +16% |
| Personal Group Bonus | | | | | | |
| Total personal Group | +20% | +22% | +24% | +25% | +26% | +27% |
| Bonus | | | | | | |

In addition to increasing PGB bonuses, the bonus plan bonuses also effectively increase the generational bonuses described in Table 2. The bonus plan bonus that a business leader earns from his or her personal group simply “carries through” when an individual breaks out from the business leader's group to become a director or other business leader themselves. Because the sponsorship lines begun by the new director, before achieving director status, were assigned to the upline business leader's “director room,” the upline business leader continues to earn the 4% bonus plan director bonus on the monthly volume of the people in that room and on any new people in their downline. The new director then starts their own “director room” from that point forward. Anyone that the new director personally sponsors, from that point on, enters their director room rather than that of the director's upline. This process continues until someone in the director's personal group breaks out to become a director.

In this example, generational bonuses (as described in Table 2) only pay a maximum of four generations deep. However, with the addition of the bonus plan bonuses, bonuses are paid on the entire downline assigned to a given business leader. Table 6 depicts bonus plan bonuses when added to generational bonuses.

TABLE 6

| | | | | | Sr. | | Sr. | | |
|---|---|---|---|---|---|---|---|---|---|
| | Sr. | | Sr. | Executive | Executive | Key | Key | Master | Pres. |
| | Director | Coor. | Coor. | Coor. | Coor. | Coor. | Coor. | Coor. | Master |
| Bonus | +4% | +6% | +6% | +8% | +8% | +9% | +9% | +10% | +11% |
| Plan | | | | | | | | | |
| Bonuses | | | | | | | | | |
| 1^{st} Gen. | 11% | 13% | 13% | 15% | 15% | 16% | 16% | 17% | 18% |
| 2^{nd} Gen. | 4% | 11% | 12% | 14% | 14% | 15% | 15% | 16% | 17% |
| 3^{rd} Gen. | 4% | 6% | 6% | 12% | 12% | 14% | 14% | 15% | 16% |
| 4^{th} Gen. | 4% | 6% | 6% | 8% | 8% | 12% | 12% | 14% | 15% |

As a business leader progresses in title or rooms, for example from a director to a senior director or from a senior director to a coordinator, the organization he or she builds in each room continues to grow as more people are sponsored and the sponsorship line grows. Bonus plan bonuses continue to pay to the bottom of a business leader's personal group. Generally speaking, the amount of the bonus plan bonus that the business leader receives depends on the assignment (room) that each distributor in the personal group was originally sponsored at. Bonus plan bonuses being paid in conjunction with both generational bonuses from business group volume and PGV bonuses is unique in the multi-level marketing industry. Also new to the multi-level marketing industry is the concept of carrying through bonus plan type bonuses from one's personal group to one's business group upon promotion to the leadership career path.

### Example 43

### Exemplary Starter Program

As mentioned above, rather than pay a percentage on the volume generated in one's personal group and business group, starter program bonuses generally pay a fixed dollar amount of up to $125 on the sale of a starter pack. This $125 is cumulative and is generally split between one or more of the sponsor and the sponsor's upline. For example, when a distributor or a business leader personally sponsors a new distributor such that the new distributor purchases a starter pack, then the sponsoring distributor or business leader earns $50. The remaining $75 ($125−$50) is then paid out depending on the assignment of the sponsor and the sponsor's upline sponsorship line. Table 7 depicts how starter program bonuses are paid out based upon the title held by the sponsor. In practice, there can be an additional room (e.g., Phase 1) where a distributor is eligible only for the $50 Personal Bonus. The room can be implemented as “Room #0.”

TABLE 7

| | Room | | | | | |
|---|---|---|---|---|---|---|
| | #1 | #2 | #3 | #4 | #5 | #6 |
| Room | Director/ | Coordinator/ | Executive Coor./ | Key Coor./ | Master | Presidential |
| Name | Sr. | Sr. Coor. | Sr. Exec. | Sr. Key Coor. | Coordinator | Master |
| | Director | Room | Coor. | Room | Room | Room |
| | Room | | Room | | | |
| Starter Program | $50 | $50 | $50 | $50 | $50 | $50 |
| Personal Bonus | | | | | | |
| Starter Program | $25 | $50 | $75 | $75 | $75 | $75 |
| Additional Bonus | | | | | | |

### Example 44

### Exemplary Qualifications to Advance in Title

Generally, to move from one room to the next in the business leader Career Path, certain requirements may have to be met. These requirements could be certain benchmarks that need to be met for personal volume, personal group volume, personally sponsoring a certain number of people in the starter program, having a given number of people in a starter program sponsorship downline, having a person in the PGV downline break out to become a business leader themselves, and/or reaching certain BGV milestones. Each of these milestones may be recurring on a monthly or promotional basis. For example, a person may have to attain and then maintain a certain PGV each month in order to progress. Alternatively, a person may simply have to re-achieve the given PGV each time they progress. In other embodiments, the milestones may be cumulative over the course of an individual's career. For example, an individual may be required to have a downline starter program sponsorship of at least 9 new sponsorees before progressing to a coordinator.

### Example 45

### Exemplary Advantages

The complete compensation plan described above can include features of a traditional Stairstep/Breakaway Plan and two separate types of assigned bonus plans. The traditional Stairstep/Breakaway Plan is a two-dimensional plan. Distributors are compensated one way on the personal group and compensated another way when the distributors break away from their personal groups. Assigned bonus plans are generally also two-dimensional. They typically offer a uni-level piece and an assigned piece, but the entire genealogy is based on the assigned relationships. In the compensation plan described above, three separate genealogical structures are utilized to define the groups and qualifications on which different types of bonuses are paid.

The Stairstep/Breakaway Plan significantly rewards building a stable customer base and teaching others to do the same. However, the actual “break away” from PGV to BGV is problematic, especially for people in the early stages of building a business, due to the sudden loss of income when an individual in a sponsor's downline breaks away. In addition, the breakaway part of the plan is, by definition, limited to paying any individual business leader on a defined number of generations, even though their organization may extend much further. Many Stairstep/Breakaway plans use bonuses similar to the bonus program bonuses, but they suffer from the limitation that a business leader is “blocked” on the bonus at the point when someone in his or her downline holds the same or higher business leader title (director, coordinator, etc.).

The starter program solves some of these difficulties through the use of the starter pack. The starter pack helps people recruit others that are interested in building a business, while at the same time ensuring that the starter pack is also a good value for a customer. The starter program rewards sponsors and sponsorship uplines on the sale of the starter packs. But, it is a limitation of the starter program that the program is based on a one-time sale, and thus a one-time bonus.

The bonus plan uses the timed/assigned bonus concept to add a completely new dimension to the compensation plan. Because of the assignment, the bonuses can truly pay to infinity—on the part of a downline's organization that began prior to the downline earning an equivalent title. The upline will be “blocked,” or not eligible to receive bonuses on the part of the downline's organization that is in sponsorship lines begun by the downline after reaching the equivalent rank. A limitation of this type of plan on its own is that while there is considerable incentive for a distributor to build toward the next level, there is less incentive for him or her to work with groups developed at earlier levels, because those groups pay less in terms of the bonus. Thus, those groups tend to receive less assistance and direction and become less profitable to both the sponsor and the enterprise as a whole.

### Example 46

### Exemplary Implementation

The following includes material that can be presented to prospective participants and explains aspects that can be integrated into the commission program described herein. The bonus amounts can be different for different activities and phases.

For over 50 years, <company> has offered people just like you, an opportunity to make a difference.

We offer life-changing products that make people and the planet healthier, and also—a life-changing opportunity for you—and the people you share it with—to do well by doing good.

We believe if each of us shares these products, this opportunity, and our vision, collectively we can change the world.

If you're on a mission to change your life, the best way to start your <company> business is to become a GOLD Ambassador with the “Global Opportunity Leadership Development” Program.

For just $<price>, the GOLD Ambassador Program's Mission PAK gives you all the essential tools—including the New Distributor Welcome Kit, the Product Action Kit collection of your choice—with PV, so you can begin <company>-izing your home while building bonus-earning volume, And the opportunity to earn additional bonuses right away.

Plus, <company> will plant 5 trees for each Mission Pack sold to offset the carbon emissions from shipping and more—so you'll actually have a net positive impact on the planet.

But if you're like most people, you'll discover that once you try <company> products, you can't help but recommend them to others—and that's where the earning opportunity really gets exciting.

For every Mission Pak you sell, you can earn up to $<bonus amount> in GOLD Ambassador Program bonuses immediately, on top of our already generous compensation plan. And based on your qualification phase, these bonuses get paid to you or your upline.

Here's how it works.

When someone just joins <company>, or is just starting to build a business, they begin in phase one—and that's the room you are in right now. Success is as easy as sharing <company>, and teaching others to do the same.

Start by personally sponsoring 3 new GOLD Ambassadors who each buy the Mission PAK. For each one of them, you'll receive a $ <bonus amount> GOLD Ambassador Bonus. When you teach them to do the same, to start sharing <company>, and your 3 have sponsored 9 other new GOLD Ambassadors so that you have a total of 12 in your group, you now qualify for Phase Two, where you can earn additional and significant GOLD bonuses.

Now the GOLD Ambassadors can be sponsored in any combination: your 3 can sponsor the 9 by each sponsoring 3; you could have 1 superstar who sponsors all 9; or you could have sponsored all 12 yourself—whatever works best for your team. The bottom line is, once you sponsor 3 and have a total of 12 new GOLD Ambassadors in your group, you move on to Phase Two where the GOLD Ambassador bonuses get even bigger. Please proceed to the phase two room.

Welcome to Phase Two. Having already established a <company> organization that includes 12 Gold Ambassadors, and probably a number or Distributors and members too, you are well on your way to building a strong and successful <company> business. Remember that as you sponsor, and as people join your organization, you are still making profit from the sale of products, and volume bonuses from our already generous compensation plan.

By the time you reach phase two, you probably hold the rank of Associate, and are getting pretty good at talking to people about <company>. Well in Phase Two, that is precisely what we want you to continue doing.

Personally sponsor another 3 new GOLD Ambassadors who sponsor any combination of 9 new GOLD Ambassadors so that building another team of 12 is your objective. And here's where things get interesting . . .

. . . because you qualified for Phase Two, you now earn $<bonus amount> for each of the 3 or any GOLD Ambassadors you personally sponsor, plus you now earn $<bonus amount> for each new GOLD Ambassador they sponsor—TO UNLIMITED LEVELS in-depth! That's right—every GOLD Ambassador those 3 people sponsor, and the GOLD Ambassadors that their people sponsor, earns you $<bonus amount>.

Even when your 3 GOLD Ambassadors sponsor 9 for a total of 12 in Phase Two, and you move on to even greater earnings in Phase Three, you will continue to earn $<bonus amount> for each new GOLD Ambassador that anyone in your Phase Two team sponsors no matter how many levels under you they appear. Look around if there are other people in the room, or look at the circles on the wall, and the floor, imagine the stability of an organization comprised of 24 GOLD Ambassadors. Think of the possibilities of being able to earn $<bonus amount> from every person these people ever sponsor to unlimited levels. Now if you are ready to learn how this could get even better, please proceed to the Phase Three room.

Welcome to Phase Three. By this time, you've probably achieved at least the rank of Director, and you're really learning that the duplication of effort pays off, so it's probably no surprise that in Phase Three, you just continue to sponsor and grow. Repeat the process again: sponsor 3 new GOLD Ambassadors and help them to sponsor a total of 12 new GOLD Ambassadors.

With each new GOLD Ambassador sponsored, it just keeps getting better. In Phase Three, you now earn $<bonus amount> for each new GOLD Ambassador that you personally sponsor, plus $<bonus amount> for each GOLD Ambassador that they sponsor—AGAIN, TO UNLIMITED LEVELS!

So even after you fulfill your qualifications and move on to Phase Four, you will continue to receive $<bonus amount> from any GOLD Ambassadors sponsored into your phase Two group, and $<bonus amount> from any GOLD Ambassadors sponsored into your phase Three group to unlimited levels.

This time though, there is an additional qualification before you can move on to the 4^{th} and most profitable phase. You still have to have your 3 personally sponsored GOLD Ambassadors and 12 in your phase Three group, but you also need to help one of your phase Three Ambassadors complete Phase One and get to Phase Two themselves by creating a group of 12 of their own. Do that and achieve the rank of Executive Coordinator, and now you are qualified to move on to the 4^{th} and final phase. In the meantime, remember: you'll keep earning GOLD Ambassador bonuses on every new GOLD Ambassador who sponsors into your Phase Two and phase Three team. Please proceed to the phase Four room.

Welcome to Phase Four. By now, you've mastered the art of duplication—and you have unlocked the door to the highest level of GOLD Ambassador bonuses. Fundamentally you are still doing the same thing, but financially it really gets exciting when you continue to sponsor and teach others to do the same.

From this point on, you now earn $<bonus amount> for any GOLD Ambassadors you personally sponsor, plus $<bonus amount> for each GOLD Ambassador sponsored by anyone in your phase Four group—again to unlimited levels.

Even after people in your organization have achieved phase Two, Three, or Four and are earning GOLD Ambassador bonuses of their own, you will continue to earn off new GOLD Ambassadors sponsored by the organization they have built as they worked to qualify for each new phase.

The GOLD Program is designed to pay upfront starter cash while you build long-term residual income. How?

By rewarding the same activities that will help build your long-term residual income from volume and leadership bonuses: introduce people to the products and the opportunity in a duplicatable manner, and lead by example when you teach them to do the same.

That's why it's so important to remember that the people in each phase are not stagnant. They learn and grow by example—so it's important to teach them to duplicate your success with the GOLD Ambassador program. When they do, you've not only earned the upfront GOLD Ambassador bonuses, but your volume and leadership bonuses will grow too. And remember: the GOLD Ambassador program simply enhances what is already the most generous compensation plan in the industry. And as you move from Phase One through Four, you're probably advancing in rank so the size of your volume and leadership bonuses are likely to be increasing as well. Look around at all the circles on the wall or on the floor. All of these people, and all of this sponsoring is your foundation for success.

Plus, all of these growth activities can help you earn Incentive Trip Points—so the rewards just keep coming. The GOLD Ambassador Program can be the door to your life-changing opportunity.

### Example 47

### Exemplary Computer Implementation

The described commission program can involve multiple relationships for a potentially very large number of people and is typically implemented on a computing system. The commission program can be implemented on any of a variety of computing devices and environments, including computers of various form factors (personal, workstation, server, handheld, laptop, tablet, or other mobile), distributed computing networks, and Web services, as a few general examples. The commission program can be implemented in hardware circuitry, as well as in software executing within a computer or other computing environment, such as described herein.

### Example 48

### Exemplary Network Implementation

The embodiments described herein can be implemented in a networking scenario such as the Internet or an intranet.

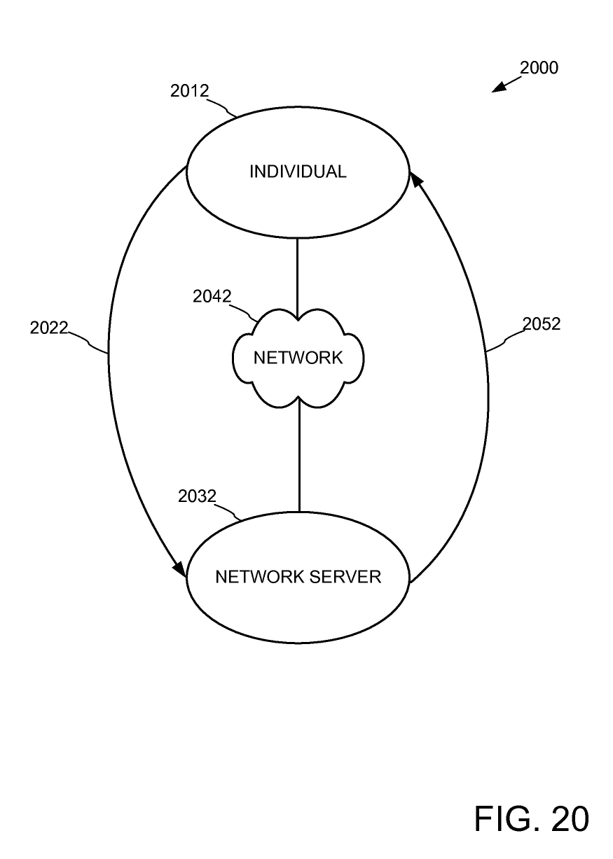

An exemplary networking scenario 2000 is shown in FIG. 20. In the scenario 2000, an individual 2012, such as a distributor or business leader, sends requests 2022 for information to a network server 2032 via a network 2042. In response, the network server 2032 provides information 2052 via the network 2042. The information 2052 can take many forms including information for accomplishing computing tasks related to a software application or other software or information related to the company.

For example, the information requested by the individual 2012 can include information related to the company such as the current or past sales volume of the individual, information about a person or persons in the individual's upline or downline, information about a product or service offered by the company, or other information.

The network information can include delivery of graphical user interface elements (e.g., hyperlinks, graphical checkboxes, graphical pushbuttons, and graphical form fields) which can be manipulated by a pointing device such as a mouse.

To accomplish delivery of the information 2052, an individual 2012 can use client software such as a web browser to access a data center associated with the network server 2032 via a web protocol such as an HTTP-based protocol (e.g., HTTP or HTTPS). Requests for information can be accomplished by activating user interface elements (e.g., those acquired through the network or otherwise) or automatically (e.g., periodically or as otherwise scheduled) by software. In such an arrangement, a variety of networks (e.g., the Internet) can be used to deliver the network information (e.g., web pages conforming to HTML or some extension thereof, or information related to the company) in response to the requests. One or more clients can be executed on one or more devices having access to the network 2042. In some cases, the requests 2022 and information 2052 can take different forms, including communication to software other than a web browser.

The technologies described herein can be used to administer software implementing the above described compensation plan (e.g., one or more applications) across a set of administered devices via a networking scenario. Administration of software can include software installation, software configuration, software management, or some combination thereof.

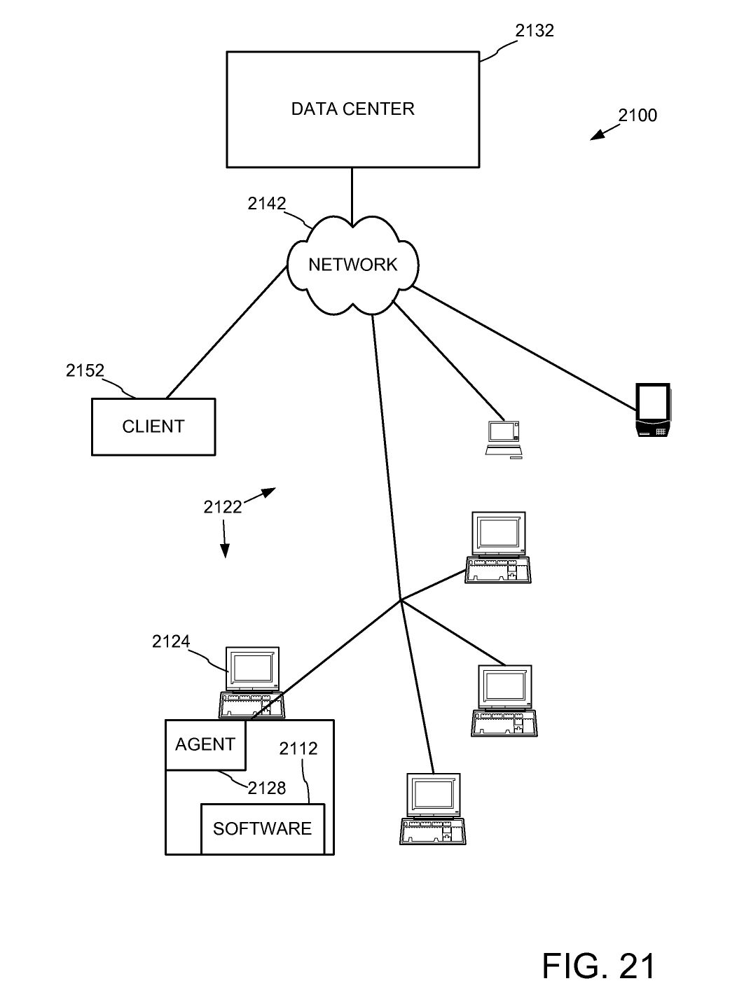

FIG. 21 shows an exemplary arrangement 2100 whereby a network provides services for administering software (e.g., administered software 2112) across a set of administered devices 2122. The administered devices 2122 are sometimes called “administered nodes.”

In the arrangement 2100, instances of the software 2112 are administered over the network via a data center 2132. The data center 2132 can be an array of hardware at one location or distributed over a variety of locations remote to the individual. Such hardware can include routers, web servers, database servers, mass storage, and other technologies appropriate for providing application services via the network 2142. Alternatively, the data center 2132 can be located at the individual's site or sites. In some arrangements, the data center 2132 can be operated by the individual.

The individual can make use of one or more client machines 2152 to access the data center 2132 via the network. For example, the client machine 2152 can execute a web browser, such as Microsoft Internet Explorer, which is marketed by Microsoft Corporation of Redmond, Wash. In some cases, the client machine 2152 may also be an administered device 2122.

The administered devices 2122 can include any of a wide variety of hardware devices, including desktop computers, server computers, notebook computers, handheld devices, programmable peripherals, and mobile telecommunication devices (e.g., mobile telephones). For example, a computer 2124 may be a desktop computer running an instance of the administered software 2112.

The computer 2124 may also include an agent 2128 for communicating with the data center 2132 to assist in administration of the administered software 2112. In one example of the network, the agent 2128 can communicate via any number of protocols, including HTTP-based protocols.

The administered devices 2122 can run a variety of operating systems, such as the Microsoft Windows family of operating systems marketed by Microsoft Corporation; the Mac OS family of operating systems marketed by Apple Computer Incorporated of Cupertino, Calif.; and others. Various versions of the operating systems can be scattered throughout the devices 2122. Although the example shows that the administered software 2112 can be managed over many administered nodes, one or more instances of the software can appear on one or more administered nodes.

In this example, the administered software 2112 includes functionality that resides locally to the computer 2124. For example, various software components, files, and other items can be acquired by any of a number of methods and reside in a computer-readable medium (e.g., memory, disk, or other computer-readable medium) local to the computer 2124. The administered software 2112 can include instructions executable by a computer and other supporting information. Various versions of the administered software 2112 can appear on the different devices 2122, and some of the devices 2122 may be configured to not include the software 2112.

### Example 49

### Exemplary Genealogies

In any of the examples herein, the following approach can be used in a multi-level marketing program. Traditionally, individuals have received compensation based upon the sales volume of the people that they sponsor. A sponsor is essentially a person who brings a new person (“sponsoree”) into the company and then acts in the capacity of a mentor or manager for that sponsoree. A sponsor's responsibilities can include selling product to their sponsorees or coaching and training their sponsors to assist them in becoming successful in the sponsoree's business. Typically, each sponsoree only has a single sponsor, and thus there is generally only one person that is directly interested in the success of that sponsoree. Introduced here is a lateral-phase movement-based commission program.

Certain of the embodiments of the invention disclosed are designed to give a sponsoree multiple simultaneous sponsors. Certain embodiments of the program are designed such that an individual may be in two compensation programs simultaneously. In this program, a sponsoree may be permanently assigned in some cases to as many as four different sponsors. The sponsors can be assigned based on one or more criteria such as seniority, influence within the company, or influence within the market. In one embodiment, sponsors are assigned based on the sequence of sponsors leading to the sponsoree. For example, if A sponsors B, B sponsors C, and C sponsors D, then D's sponsors would likely include C, B, and A until certain criterion were met. One example might be to assign a sponsoree to one sponsor who is at a relatively low level within the company, and then assign the sponsoree to an additional sponsor or sponsors who have already achieved higher levels; alternatively a sponsoree could be assigned to just one sponsor if the sponsor had achieved a high level within the company.

In certain embodiments, when a person joins the program and begins to act as a sponsor, the sponsor earns 1^{st} tier bonuses on products that sponsorees purchased from the sponsor, as long as the sponsor qualifies according to criterion established by the particular business implementing the system. These 1^{st} tier bonuses may be monetary bonuses, though other compensation is herein envisioned. The 1^{st} tier program may also include a “stair step breakaway” compensation plan. This compensation plan is designed such that a sponsor receives a certain amount of the income based upon the further purchase of product from the company by a sponsoree whom they sponsor.

It is further envisioned that the sponsor may be part of the 1^{st} tier program and also a member of a 2^{nd} tier program. In terms of the 2^{nd} tier program, the sponsor will not earn income in the same manner. Instead, the income is initially reserved for the sponsor's sponsors, as will be described below. This serves to create a situation where two or more people, particularly the sponsor's sponsors, are personally interested in the success of the sponsor. It is envisioned that this will increase motivation by helping provide the sponsor with a greater support base with an economic incentive to assist the sponsor to develop their own business.

The 2^{nd} tier program consists of a series of phases. In the 2^{nd} tier program, a sponsor progresses through the series of phases and payments are assigned according to the phase that a sponsor is in when they sponsor a sponsoree. When the sponsor begins, they create new “genealogies” by meeting a given set of requirements before promoting to the next phase. A sponsor's genealogy may include the sponsorees that he or she is sponsoring, and include anyone that those sponsorees are sponsoring in turn. This relationship can continue through multiple levels, and there is no limit to the number of levels deep that a genealogy can go. In one embodiment a sponsor may stop earning compensation from a sponsoree if the sponsoree achieves a certain level. The sponsor may also stop earning income from any genealogies created by the sponsoree after the sponsoree has achieved that level. However, the sponsor would continue to earn income from any genealogies the sponsoree created before achieving that level.

As an example, the sponsor might be required to sponsor a minimum of three personal and twelve total sponsorees being sponsored in a given phase. A “personal” sponsoree is defined as a sponsoree that the sponsor specifically brings into the company. A sponsoree who counted toward the sponsor's total but was not a “personal” sponsoree would be a sponsoree that was brought into the company further down the sponsor's genealogy. For example, if A sponsored B, and B sponsored C, then A would “personally” sponsor B and not C, however both B and C would be in A's genealogy and count towards A's total. The genealogies that the sponsor created while in a phase 1 designation remain as part of their phase 1 group permanently. Those genealogies are assigned the moment that the sponsor-sponsoree relationships begin and do not change unless there is a special circumstance such as a sponsor leaving the company or some other similar change in circumstance. It is envisioned that bonuses may be included for the 2^{nd} tier as well, and may be monetary or some other form of bonus. For example, a bonus may be included for each “personal” sponsoree, though other configurations would be included. Typically, a sponsor earns this bonus whenever a sponsoree purchases a given amount of product from the company.

When a sponsor enters phase 2, the sponsor begins to build new genealogies. For those genealogies created while in this phase, regardless of how many levels deep the genealogies go, the sponsor earns a monetary phase 2 bonus when the sponsoree purchases a given amount of product from the company. This bonus may include different rates depending on the geographic location of the sponsoree. For example, the sponsor might earn $25.00 for sponsorees in the United States or in Canada, and only earn $5.00 for sponsorees in Mexico. All of the sponsorees in this phase may be assigned to the sponsor in the sponsor's phase 2 genealogy when the sponsorees enroll in the 2^{nd} tier program. Additionally, in certain embodiments, when a sponsoree that is sponsored by a phase 2 sponsor sponsors a person in turn, then the original phase 2 sponsor also receives the phase 2 monetary bonus. By way of example, presume that A is in phase 2. A sponsors B and receives the phase 2 monetary bonus when B purchases a certain amount of product from the company. If B sponsors C, then A also receives the phase 2 monetary bonus when C purchases a certain amount of product from the company.

Once a sponsor has completed phase 2 by meeting certain requirements, for example sponsoring three personal and twelve total sponsorees, the sponsor may be promoted to phase 3. At this point the sponsor creates new genealogies. The sponsorees sponsored in these genealogies will be assigned to the sponsor as both the phase 2 and phase 3 sponsor, thus the sponsor may earn both the phase 2 and the phase 3 bonus when these sponsorees purchase a certain amount of product from the company. For example, the sponsor might earn both a bonus of $25.00 for the phase 2 sponsorship and another bonus of $25.00 for the phase 3 sponsorship. As in phase 2, this bonus would be for any genealogies created in this phase, regardless of how many levels deep the genealogy goes. In certain embodiments, even though a sponsor progresses to phase 3 or higher, the sponsor continues to earn phase 2 bonuses on sponsorees added to the sponsor's phase 2 genealogy as the sponsorees in that genealogy continue to sponsor others.

In certain embodiments, once a sponsor has completed phase 3 by meeting certain requirements, for example sponsoring three personal and twelve total sponsorees, helping one sponsoree become a phase 2 sponsor, and be an executive coordinator, the sponsor starts new genealogies again. Sponsorees sponsored in this phase will be assigned to the sponsor as a phase 2, phase 3, and phase 4. The sponsor earns the phase 2 bonus, the phase 3 bonus, and the phase 4 bonus for this state when the sponsoree purchases a certain amount of product from the company. For example, the sponsor may earn the phase 2 bonus of $25.00, the phase 3 bonus of $25.00, and the phase 4 bonus of $25.00 for a total bonus of $75.00. As in phases 2 and 3, this bonus may be effective for any sponsoree in this genealogy, regardless of how many levels deep the genealogy goes. In certain embodiments, a phase 4 sponsor will also continue to earn phase 2 bonuses on the sponsor's phase 2 genealogy, and phase 2 and phase 3 bonuses on the sponsor's phase 3 genealogy as sponsorees in those respective genealogies continue to sponsor others as described above.

In certain embodiments sponsorees assigned to a sponsor as part of the sponsor's phase 1 group, even though the sponsor is now a phase 4 sponsor, remain assigned to the sponsor at the phase where the sponsor-sponsoree relationship was created. That relationship does not change. Additionally, the sponsorees that were in a sponsor's phase 2 genealogy remain assigned to the sponsor only as a phase 2, as do any people those sponsorees sponsor in turn. Thus, in such embodiments of the invention, even if an original sponsor is now in phase 4, they still only receive the phase 2 compensation from a sponsoree that they originally sponsored while they were in that phase and from people in that sponsoree's genealogy whether before or after the sponsor has been promoted to the next phase. Phase 3 relationships would hold in a similar manner.

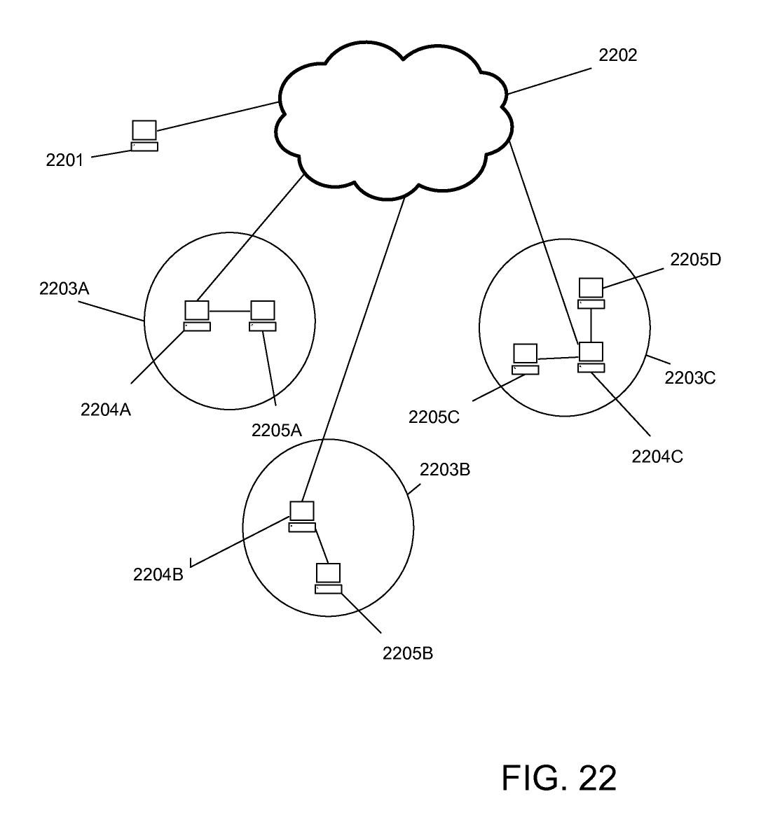

In certain embodiments it is envisioned that this program may be implemented via a computer. Data generated by sponsors and sponsorees actions in the program may be stored and managed by a computer. In certain embodiments utilizing a computer, a sponsor and/or a sponsoree in the sponsor's genealogy have the ability to access data about the sponsoree. In this way a sponsor can view the progress of sponsorees in their genealogy and determine changes to any motivation or business plan that the sponsor may be implementing or may be able to view bonuses due based on the manipulation of the program data. FIG. 22 depicts a sponsor 2201 with access to a computer network 2202. The sponsor 2201 has three genealogies 2203a-c. Each genealogy 2203a-c has a personal sponsoree 2204a-c, respectively. Additionally, personal sponsoree 2204a is sponsoring another sponsoree 2205a who is included in the sponsor's 2201 genealogy 2203a. Similarly, personal sponsoree 2204b is sponsoring sponsoree 2205b within the second genealogy 2203b. Finally, personal sponsoree 2204c is sponsoring sponsorees 2205c, 2205d within the third genealogy 2203c. The sponsor 2201 can have access through the computer network 2202 to data about any of the sponsorees 2204a-c, 2205a-d within each of the sponsor's genealogies 2203a-c.

Though only four phases are discussed herein, other similar plans may have more or fewer phases for promotion according to factors such as the industry or the business model. Additionally, the requirements described herein for promotion are merely exemplary and other options such as different numbers of sponsorees or different levels to which a sponsoree must be sponsored are included in this disclosure. The description of the geographical locations and the bonus schemes are merely exemplary and there are numerous variations on the amount paid or the locations envisioned within this disclosure.

### Example 50

### Exemplary Computing Environment

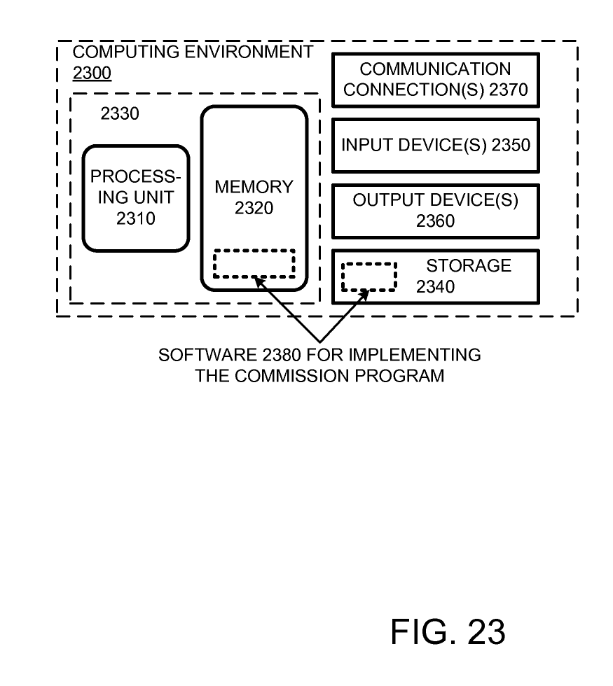

FIG. 23 illustrates a generalized example of a suitable computing environment 2300 in which the described techniques can be implemented. The computing environment 2300 is not intended to suggest any limitation as to scope of use or functionality, as the technologies may be implemented in diverse general-purpose or special-purpose computing environments.

With reference to FIG. 23, the computing environment 2300 includes at least one processing unit 2310 and memory 2320. In FIG. 23, this basic configuration 2330 is included within a dashed line. The processing unit 2310 executes computer-executable instructions and may be a real or a virtual processor. In a multi-processing system, multiple processing units execute computer-executable instructions to increase processing power. The memory 2320 may be volatile memory (e.g., registers, cache, RAM), non-volatile memory (e.g., ROM, EEPROM, flash memory, etc.), or some combination of the two. The memory 2320 can store software 2380 implementing any of the technologies described herein (e.g., storing computer-executable instructions for performing any of the methods described herein).

A computing environment may have additional features. For example, the computing environment 2300 includes storage 2340, one or more input devices 2350, one or more output devices 2360, and one or more communication connections 2370. An interconnection mechanism (not shown) such as a bus, controller, or network interconnects the components of the computing environment 2300. Typically, operating system software (not shown) provides an operating environment for other software executing in the computing environment 2300, and coordinates activities of the components of the computing environment 2300.

The storage 2340 may be removable or non-removable, and includes magnetic disks, magnetic tapes or cassettes, CD-ROMs, CD-RWs, DVDs, flash memory, or any other computer-readable media which can be used to store information and which can be accessed within the computing environment 2300. The storage 2340 can store software 2380 containing instructions for any of the technologies described herein.

The input device(s) 2350 may be a touch input device such as a keyboard, mouse, pen, or trackball, a voice input device, a scanning device, or another device that provides input to the computing environment 2300. For audio, the input device(s) 2350 may be a sound card or similar device that accepts audio input in analog or digital form, or a CD-ROM reader that provides audio samples to the computing environment. The output device(s) 2360 may be a display, printer, speaker, CD-writer, or another device that provides output from the computing environment 2300.

The communication connection(s) 2370 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor (e.g., which is implemented via a real processor). Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Example 51

### Exemplary Data Processing System

Any of the methods described herein can be implemented in a data processing system (e.g., computer or the like) such as the computing environment described herein. In such a case, the system can comprise memory in which are stored computer-executable instructions to perform any of the methods described herein and one or more processors (e.g., coupled to the memory) configured to execute the computer-executable instructions stored in memory to implement the method acts described.

### Methods in Computer-Readable Media

Any of the methods described herein can be implemented by computer-executable instructions in one or more computer-readable media (e.g., computer-readable storage media or other tangible media). The technologies described herein can be implemented in a variety of programming languages.

### Exemplary Computer Program Product

In any of the examples herein, methods can be embodied in a computer program product. For example, a physical computer-readable medium storing computer-executable instructions performing any of the methods described herein can be offered as a product for use in a computing environment, such as a personal computer, handheld electronic device, or the like.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

1. A computer-implemented method comprising:
when a sponsored distributor is sponsored into an organization, statically assigning titled distributor associations between upline distributors upline from the sponsored distributor and the sponsored distributor;
calculating a compensation amount for at least one distributor based at least on the titled distributor associations between the upline distributors and the sponsored distributor; and
storing the compensation amount.

2. The computer-implemented method of claim 1 further comprising:
as the sponsored distributor advances in title, maintaining the titled distributor associations between the upline distributors and the sponsored distributor.

3. The computer-implemented method of claim 1 wherein determining and storing titled distributor associations comprises:
assigning upline distributors to an upline assignment summary of the sponsored distributor.

4. The computer-implemented method of claim 3 wherein:
the upline assignment summary of the sponsored distributor comprises a plurality of entries ordered by respective title names.

5. The computer-implemented method of claim 4 wherein:
assigning upline distributors to an upline assignment summary of the sponsored distributor comprises:
determining a title name of a sponsoring distributor;
assigning the sponsoring distributor to entries of the upline assignment summary having a title name equal to or less than the sponsoring distributor; and
for entries having a title name greater than the sponsoring distributor, copying corresponding entries from an upline assignment summary of the sponsoring distributor.

6. The computer-implemented method of claim 5 wherein calculating the compensation amount comprises:
allocating compensation for sales associated with the sponsored distributor to distributors listed in the upline assignment summary of the sponsored distributor.

7. The computer-implemented method of claim 5 wherein calculating the compensation amount comprises:
determining which upline distributors have titled rooms to which the sponsored distributor is assigned according to the upline assignment summary of the sponsored distributor; and
allocating compensation for sales associated with the sponsored distributor to the upline distributors assigned to the titled rooms.

8. The computer-implemented method of claim 1 wherein:
the titled distributor associations implement titled room assignments that assign the sponsored distributor to titled rooms for respective of the upline distributors.

9. The computer-implemented method of claim 8 wherein calculating a compensation amount comprises:
for sales of the sponsored distributor, calculating a bonus for distributors having titled rooms to which the sponsored distributor is assigned.

10. The computer-implemented method of claim 9 further comprising:
supplementing the compensation amount with a generation bonus independent of titled room assignment.

11. The computer-implemented method of claim 9 further comprising:
supplementing the compensation amount with a leadership bonus independent of titled room assignment.

12. The computer-implemented method of claim 9 further comprising:
as the sponsored distributor advances in title, maintaining assignment of the titled rooms to which the sponsored distributor is assigned.

13. The computer-implemented method of claim 9 wherein calculating the compensation amount comprises:
applying different percentages for at least two of the titled rooms.

14. The computer-implemented method of claim 9 wherein calculating compensation amounts comprises:
associating percentages with respective of the titled rooms; and
for a distributor appearing in a titled room, determining a compensation amount for the distributor via applying a percentage associated with the titled room to sales for the sponsored distributor.

15. The computer-implemented method of claim 9 wherein calculating the compensation amount comprises:
identifying upline distributors listed in an upline assignment summary of a selling distributor; and
allocating compensation for sales associated with the selling distributor to the upline distributors listed in the upline assignment summary of the selling distributor.

16. The computer-implemented method of claim 9 wherein the assigning comprises:
assigning a distributor to more than one of the titled rooms of a single distributor.

17. The computer-implemented method of claim 9 wherein the assigning comprises:
responsive to determining that an immediately sponsoring distributor is of top level, assigning the sponsored distributor to all titled rooms of the immediately sponsoring distributor.

18. The computer-implemented method of claim 9 further comprising:
before assigning a subject distributor to any titled room of the sponsored distributor, determining whether the subject distributor has met qualification requirements; and
responsive to determining that the subject distributor has not met the qualification requirements, inhibiting assignment of the subject distributor to any titled room of the sponsored distributor.

19. The computer-implemented method of claim 9 further comprising:
before assigning any distributor to a titled room of the sponsored distributor, determining whether the subject distributor has met qualification requirements; and
responsive to determining that the sponsored distributor has not met the qualification requirements, inhibiting assignment of any distributor to any titled room of the sponsored distributor.

20. The computer-implemented method of claim 9 further comprising:
determining sales associated with the sponsored distributor on an ongoing basis.

21. The computer-implemented method of claim 9 further comprising:
determining sales associated with the sponsored distributor as sales of more than one product line.

22. The computer-implemented method of claim 9 further comprising:
determining sales associated with the sponsored distributor as sales of a single product.

23. The computer-implemented method of claim 1 wherein:
statically assigning titled distributor associations comprises assigning the sponsored distributor to titled rooms for respective of the upline distributors.

24. The computer-implemented method of claim 23 wherein:
assigning the sponsored distributor to titled rooms comprises assigning the sponsored distributor to at least one titled room of a directly sponsoring distributor according to a current title of the directly sponsoring distributor.

25. The computer-implemented method of claim 23 wherein:
assigning the sponsored distributor to titled rooms comprises assigning the sponsored distributor to at least one titled room of an upline distributor according to an upline summary of a directly sponsoring distributor.

26. The computer-implemented method of claim 23 wherein:
assigning the sponsored distributor to titled rooms comprises assigning the sponsored distributor to titled rooms of upline distributors according to a current title of a directly sponsoring distributor and an upline summary of the directly sponsoring distributor.

27. The computer-implemented method of claim 26 wherein:
the upline summary of the directly sponsoring distributor comprises titled distributor associations stored when the directly sponsoring distributor was sponsored.

28. One or more computer-readable storage media having stored thereon computer-executable instructions for performing the method of claim 1.

29. (canceled)

30. One or more computer-readable storage media comprising computer-executable instructions for performing a method comprising:
when a sponsored distributor is sponsored by a sponsoring distributor, determining titled room assignments for the sponsored distributor via (a)-(c) with an upline assignment summary of the sponsored distributor:
(a) determining a title name of a sponsoring distributor;
(b) assigning the sponsoring distributor to entries of the sponsored distributor's upline assignment summary having a title name equal to or less than the sponsoring distributor; and
(c) for entries of the sponsored distributor's upline assignment summary having a title name greater than the sponsoring distributor, copying corresponding entries from an upline assignment summary of the sponsoring distributor; and
based at least on sales by the sponsored distributor, allocating a sales-based commission based at least on sales by the sponsored distributor among distributors appearing in entries of the upline assignment summary according to percentages associated with respective entries of the upline assignment summary.

31. A computer system comprising:
one or more processors;
memory coupled to the one or more processors;
a plurality of stored nodes representing respective distributors in a sales organization, wherein nodes are associated with respective title names;
a plurality of stored data structures representing titled rooms for respective of the stored nodes; and
a compensation engine configured to calculate a go-forward bonus for a subject distributor represented by a node and having a plurality of distributors assigned to titled rooms according to titled room assignment of the subject distributor.

32. The computer system of claim 31 wherein the stored data structures representing titled rooms for respective of the stored nodes comprise:
for a represented distributor, an upline assignment summary comprising a plurality of entries indicating to which titled rooms the represented distributor is assigned.

33. A computer-readable storage medium containing instructions which, when run on a computer, cause a computer to perform a method of increasing an individual's compensation comprising:
determining a position of a business leader within a sales enterprise;
based upon the position of the business leader within the sales enterprise, determining a bonus program bonus to be paid to the business leader;
determining a personal group bonus to be paid to the business leader;
determining a business group bonus to be paid to the business leader;
increasing each of the personal group bonus and the business group bonus of the business leader by the bonus program bonus to produce an increased personal group bonus and an increased business group bonus; and
outputting an indication of the increased personal group bonus and the increased business group bonus.

34. The computer-readable storage medium of claim 33 further comprising instructions for:
determining a generational upline of the business leader comprising one or more business leaders;
determining a level upline of the business leader comprising one or more of the group of business leaders and distributors, and wherein at least one person in the level upline is not in the generational upline;
determining a first additional bonus to at least one or more business leaders in the business leader's generational upline based at least in part upon the bonus program bonus;
determining a second additional bonus to at least one or more distributors in the business leader's level upline based at least in part upon the bonus program bonus;
wherein the first or second additional bonus is a differential bonus; and
wherein the first or second additional bonus is applicable to a higher number of people than the business group bonus.

35. A computer-readable storage medium containing instructions which, when run on a computer, cause a computer to perform a method of increasing an individual's compensation comprising:
determining a position of a business leader within a sales enterprise;
based upon the position of the business leader within the sales enterprise, determining an amount that should be paid to the business leader when the business leader sponsors a new entrant into the sales enterprise;
based upon the position of the business leader within the sales enterprise, determining an amount that should be paid to at least one other person in the sales enterprise when the business leader sponsors the new entrant into the sales enterprise; and
outputting an indication of the amount that should be paid to the business leader; and
outputting an indication of the amount that should be paid to the at least one other person in the sales enterprise.

36. A computer-implemented system for managing business relationships in a multi-level marketing program comprising a method stored on a computer-readable medium and means for implementing said method, the method comprising:
assigning an individual to at least two direct sponsors who receive compensation dependent upon sales volume of the individual;
enrolling the individual in a first compensation plan as a sponsor wherein the individual receives compensation dependent upon a sales volume of a first and a second sponsoree, and wherein the individual is implementing a business plan with regard to the first and the second sponsoree;
enrolling the individual in a second compensation plan as a sponsor, said second compensation plan comprising:
at least two phases;
wherein a sponsor in a first phase earns a first amount of compensation based upon a sales volume of the first sponsoree;
wherein a sponsor in a second phase earns a second amount of compensation based upon a sales volume of the second sponsoree;
wherein the sponsor continues to earn a third amount of compensation for each person down-line from the first sponsoree based upon the sales volume of that person;
wherein the third amount of compensation may not be equal to the first amount of compensation; and
wherein the sponsor continues to earn the second amount of compensation for each person down-line from the second sponsoree based upon the sales volume of that person;
collecting a set of data about the first and the second sponsoree; and
allowing the sponsor to access the data and make changes to the business plan with respect to the first and the second sponsoree.

37. A data processing system for managing a compensation plan for a plurality of participants to a multi-level marketing enterprise, the data processing system comprising:
at least one input device;
at least one output device;
at least one storage device; and
at least one computer processor operable to:
determine a position of a business leader within a sales enterprise;
based upon the position of the business leader within the sales enterprise,
determine a bonus program bonus to be paid to the business leader;
determine a personal group bonus to be paid to the business leader determine a business group bonus to be paid to the business leader;
increase each of the personal group bonus and the business group bonus of the business leader by the bonus program bonus to produce an increased personal group bonus and an increased business group bonus; and
output an indication of the increased personal group bonus and the increased business group bonus.
